(19) United States
(12) Patent Application Publication
(10) Pub. No.: US 2025/0098038 A1
(43) Pub. Date: Mar. 20, 2025

(54) INDUCTION HEATING APPARATUS HAVING MULTILAYER CIRCUIT BOARDS ON WHICH HEATING COILS ARE PRINTED

(71) Applicant: Samsung Electronics Co., Ltd., Suwon-si (KR)

(72) Inventors: Younghoon WOO, Suwon-si (KR); Kyounghwan KIM, Suwon-si (KR); Kyunghoon JUNG, Suwon-si (KR); Jonghun HA, Suwon-si (KR)

(73) Assignee: Samsung Electronics Co., Ltd., Suwon-si (KR)

(21) Appl. No.: 18/962,579

(22) Filed: Nov. 27, 2024

Related U.S. Application Data
(63) Continuation of application No. PCT/KR2024/013058, filed on Aug. 30, 2024.

(30) Foreign Application Priority Data
Aug. 30, 2023 (KR) 10-2023-0114671
Mar. 6, 2024 (KR) 10-2024-0032252

(51) Int. Cl. H05B 6/06; H05B 6/12

(52) U.S. Cl. CPC H05B 6/062; H05B 6/1245; H05B 2213/05; H05B 2213/06

(57) ABSTRACT

An induction heating apparatus with patterned heating coils includes a heating coil board including a vessel sensing coil configured to detect a cooking vessel, a plurality of heating coil pattern layers in which heating coils are printed and patterned, and at least two pre-impregnated material (prepreg) insulation layers positioned between two adjacent heating coil pattern layers to insulate and bond the plurality of heating coil pattern layers.

### CROSS REFERENCE TO THE RELATED APPLICATION(S)

This application is a continuation application, filed under 35 U.S.C. § 111(a), of International Application PCT/KR2024/013058 filed on Aug. 30, 2024, and is based on and claims priority under 35 U.S.C. § 119 to Korean Patent Applications No. 10-2023-0114671, filed on Aug. 30, 2023, and Korean Patent Applications No. 10-2024-0032252, filed on Mar. 6, 2024 in the Korean Intellectual Property Office, the disclosures of which are incorporated by reference herein in their entireties.

### TECHNICAL FIELD

The disclosure relates to an induction heating apparatus having a plurality of multi-layer circuit boards including a heating coil board on which heating coils are printed.

### BACKGROUND ART

Various types of cooking appliances are used to heat food at home or in restaurants. Gas stoves fueled by gas were widely used, but recently, cooking appliances that use electricity instead of gas to heat objects to be heated, e.g., cooking vessels such as pots, have become more prevalent.

Methods of heating an object to be heated are largely divided into resistive heating and induction heating. The resistive heating (or electric resistive heating) method is a method of heating an object to be heated (e.g., a cooking vessel) by transferring heat generated when current is passed through a metal resistance wire or a non-metallic heating element such as silicon carbide to the object through radiation or conduction. The induction heating method is a method that uses a magnetic field generated around a coil when high-frequency power of a certain magnitude is applied to the coil to generate eddy currents in an object to be heated, which is made of metal, so that the object itself is heated. An induction range using the induction heating method generally has a working coil (heating coil) in a corresponding area in order to heat each of a plurality of objects to be heated (cooking vessels).

An induction range is a cooking appliance using the principle of induction heating, and is commonly referred to as an induction cooktop, an induction heating device, or an induction cooking device. Unlike gas stoves, induction ranges do not consume oxygen and do not emit waste gas, which may reduce indoor air pollution and suppress an indoor temperature rise. Furthermore, induction ranges use an indirect method of inducing heat into an object to be heated, have high energy efficiency and high stability, and have a low risk of burns because heat is generated directly in the object itself without heating a contact surface, and due to these advantages, the demand for induction ranges has been continuously increasing in recent years.

Recently, a type of induction range which allows an object to be heated to be placed freely anywhere on a top plate (hereinafter referred to as an ‘Anyplace induction range’) has been developed. This type of induction range is capable of inductively heating an object to be heated regardless of a size and a location of the object within an area where a plurality of heating coils exist.

An induction range usually includes a heating coil wound with a copper wire. In order to improve productivity, a structure in which the heating coil is printed onto a board is required. Because a heating coil in the induction range needs to be able to conduct a large amount of current, in the manufacturing of a heating coil to be printed on the board, it is necessary to precisely design a thickness and a width of a pattern, a lamination thickness, etc. when the heating coil is printed on the board.

### DISCLOSURE

### Technical Solution

According to an embodiment of the disclosure, an induction heating apparatus may include a plurality of heating coil pattern layers in which heating coils are printed and patterned, a vessel sensing coil configured to detect a cooking vessel, a heating coil board including heating coils to heat the cooking vessel. The heating coil board may be a plurality of heating coil pattern layers in which the heating coils are printed and patterned and a plurality of insulating layers for insulation between the plurality of heating coil pattern layers. Each of the plurality of insulating layers may include at least two pre-impregnated material (prepreg) insulation layers.

Each of the plurality of insulating layers may comprise a resin content of 60% to 80% of a total composition of each of the plurality of insulation layers.

A height of a conductor of each of the plurality of heating coil pattern layers included in the heating coil board may be 60 micrometers (μm) or more, and each of the plurality of insulating layers may have a thickness of 140 μm or less before a hot pressing process.

The induction heating apparatus may further comprise a temperature sensor configured to detect a temperature of the cooking vessel. The heating coil board may comprise a hole through which the temperature sensor passes.

The heating coil board may comprise a vessel sensing coil layer, and the vessel sensing coil layer including the vessel sensing coil as an uppermost layer.

The heating coil board may further comprise an insulating layer positioned between the vessel sensing coil layer and a heating coil pattern layer adjacent to the vessel sensing coil layer among the plurality of heating coil pattern layers.

The plurality of heating coil pattern layers may comprise at least four layers.

The plurality of heating coil pattern layers may comprise eight or more layers.

The plurality of heating coil pattern layers may have a first heating coil pattern layer; a second heating coil pattern layer; a third heating coil pattern layer; a fourth heating coil pattern layer; a fifth heating coil pattern layer; a sixth heating coil pattern layer; a seventh heating coil pattern layer; and an eighth heating coil pattern layer, among the plurality of heating coil pattern layers, the first heating coil pattern layer, the second heating coil pattern layer, the third heating coil pattern layer, the fourth heating coil pattern layer are electrically connected in parallel, and the fifth heating coil pattern layer, the sixth heating coil pattern layer, the seventh heating coil pattern layer, and the eighth heating coil pattern layer are electrically connected in parallel, and a pair of the first heating pattern layer and the eighth heating pattern layer, a pair of the second heating pattern layer and the seventh heating pattern layer, a pair of the third heating pattern layer and the sixth heating pattern layer, and a pair of the fourth heating pattern layer and the fifth heating pattern layer are each electrically connected in series.

A thickness of the heating coil board may be 3.3 mm or less.

Before the hot-pressing process, each of the plurality of insulating layers may be formed by stacking two prepreg insulation layers each having a thickness of 70 μm or less.

The heating coil board may further comprise a vessel sensing coil layer, and the vessel sensing coil layer including the vessel sensing coil as an uppermost layer, and the vessel sensing coil layer further comprises a temperature detector configured to measure a temperature of the heating coil board.

The induction heating apparatus may further comprise a processor configured to control a heating output through the heating coil board to be reduced in response to the temperature of the heating coil board measured by the temperature detector being higher than or equal to a predetermined overheating threshold temperature.

The temperature detector may comprise a positive temperature coefficient (PTC) thermistor or a negative temperature coefficient (NTC) thermistor.

The uppermost layer among the plurality of heating coil pattern layers may comprise the vessel sensing coil.

The induction heating apparatus may further comprise an inverter board connected to the heating coil board by a connector. A lowermost layer of the heating coil board comprises a signal layer for connector connection, which is to be connected to the inverter board by the connector.

The connector may be mounted on a lower portion of the heating coil board, and the inverter board may comprise at least one inverter board connector configured to accommodate the connector and mounted vertically on the inverter board.

The induction heating apparatus may further comprise an intermediate board between the heating coil board and the inverter board, the intermediate board comprising: a memory storing a program for controlling operation of the induction heating apparatus; and a processor configured to execute the program stored in the memory to control the induction heating apparatus. The intermediate board includes a hole through which the connector passes.

An amount of copper used in a raw printed circuit board (PCB) for the plurality of heating coil pattern layers may be about 2 ounces to about 3 ounces.

A method of producing a heating coil board for an induction heating apparatus, the method may comprise: forming a laminated board including: a vessel sensing coil layer having a patterned vessel sensing coil; a plurality of heating coil pattern layers in which heating coils are printed and patterned; and an insulating layer positioned between two adjacent heating coil pattern layers among the plurality of heating coil pattern layers to insulate and bond the plurality of heating coil pattern layers; and producing the heating coil board by hot-pressing the laminated board. The insulating layer is formed by overlapping a plurality of insulating layers.

### DESCRIPTION OF DRAWINGS

FIG. 1A is a diagram illustrating an induction heating apparatus according to an embodiment of the disclosure.

FIG. 1B is a diagram illustrating an induction heating apparatus according to an embodiment of the disclosure.

FIG. 2 is a cross-sectional view of a cooking vessel placed on an induction heating apparatus, according to an embodiment of the disclosure.

FIG. 3 is an inverter circuit diagram of an induction heating apparatus for operating a plurality of heating coils, according to an embodiment of the disclosure.

FIG. 4 illustrates an induction heating apparatus using a quadrilateral heating coil, according to an embodiment of the disclosure.

FIG. 5 illustrates an induction heating apparatus together with heating coils, according to an embodiment of the disclosure.

FIG. 6 illustrates a heating coil wound in an Anyplace induction heating apparatus.

FIG. 7 illustrates the appearance of a wound heating coil.

FIG. 8 illustrates a heating coil board of an induction heating apparatus, according to an embodiment of the disclosure.

FIG. 9A is a plan view of a heating coil board according to an embodiment of the disclosure.

FIG. 9B is a cross-sectional view illustrating interlayer connections in a heating coil board, according to an embodiment of the disclosure.

FIG. 9C is a cross-sectional view illustrating a heating coil board having a 16-layer structure and series-parallel connections between the heating coil patterns, according to an embodiment of the disclosure.

FIG. 10 illustrates a pattern layer including a vessel sensing coil, according to an embodiment of the disclosure.

FIG. 11 illustrates a process of manufacturing a heating coil board of an induction heating apparatus, according to an embodiment of the disclosure.

FIG. 12 illustrates layers constituting a heating coil board, according to an embodiment of the disclosure.

FIG. 13 illustrates a heating coil pattern width specification according to an embodiment of the disclosure.

FIG. 14 illustrates a partial cross-section of a laminated board according to an embodiment of the disclosure.

FIG. 15 is a characteristic curve of a temperature detector according to an embodiment of the disclosure.

FIG. 16 is a characteristic curve of a temperature detector according to an embodiment of the disclosure.

FIG. 17 illustrates a temperature detection circuit according to an embodiment of the disclosure.

FIG. 18 illustrates a temperature detection circuit according to an embodiment of the disclosure.

FIG. 19 illustrates a structure in which boards of an induction heating apparatus are connected to each other, according to an embodiment of the disclosure.

FIG. 20 illustrates a structure in which a connector is connected to a heating coil board in an induction heating apparatus, according to an embodiment of the disclosure.

FIG. 21 illustrates a structure in which a connector is mounted on a back surface of a heating coil board in an induction heating apparatus, according to an embodiment of the disclosure.

FIG. 22 is a block diagram of an induction heating apparatus according to an embodiment of the disclosure.

FIG. 23 is a flowchart of a method of producing a heating coil board, according to an embodiment of the disclosure.

### MODE FOR INVENTION

Terms used in the disclosure will now be briefly described and then an embodiment of the disclosure will be described in detail.

The terms used in the disclosure are general terms currently widely used in the art based on functions described in an embodiment of the disclosure, but may have different meanings according to an intention of one of ordinary skill in the art, precedent cases, advent of new technologies, etc. Furthermore, some particular terms may be arbitrarily selected by the applicant, and in this case, the meaning of the selected terms will be described in detail in the detailed description of the disclosure. Thus, the terms used herein should be defined not by simple appellations thereof but based on the meaning of the terms together with the overall description of the disclosure.

Throughout the disclosure, the expression “at least one of a, b or c” indicates only a, only b, only c, both a and b, both a and c, both b and c, all of a, b, and c, or variations thereof.

Throughout the specification, when a part “includes” or “comprises” an element, unless there is a particular description contrary thereto, it is understood that the part may further include other elements, not excluding the other elements. Furthermore, as used herein, terms such as “portion,” “module,” etc. indicate a unit for processing at least one function or operation and may be embodied as hardware or software or a combination of hardware and software.

An embodiment of the disclosure will now be described more fully hereinafter with reference to the accompanying drawings so that the embodiment may be easily implemented by one of ordinary skill in the art. However, an embodiment of the disclosure may be implemented in different forms and should not be construed as being limited to an embodiment of the disclosure set forth herein. In addition, parts not related to descriptions of the disclosure are omitted to clearly explain an embodiment of the disclosure in the drawings, and like reference numerals denote like elements throughout.

An induction heating apparatus induces a magnetic field in a heating coil in order to heat a cooking vessel, and the induced magnetic field causes eddy currents to flow through the cooking vessel, thereby heating the cooking vessel. In this case, when the heating coil is printed on a printed circuit board (PCB), assembly is simplified and the durability of the induction heating apparatus is increased. However, when the heating coil is printed on the board (the PCB), a large current flows in the heating coil, which may cause the board to overheat, and when a plurality of heating coil pattern layers are formed, insulation also needs to be properly designed.

Accordingly, according to an embodiment of the disclosure, there is provided an induction heating apparatus including a heating coil board having a plurality of heating coil pattern layers. In the disclosure, a board may include a PCB on which a patterned circuit is printed. When the plurality of heating coil pattern layers are stacked, an insulating layer may be included therebetween.

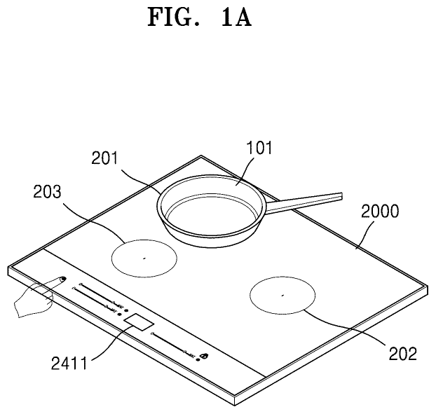

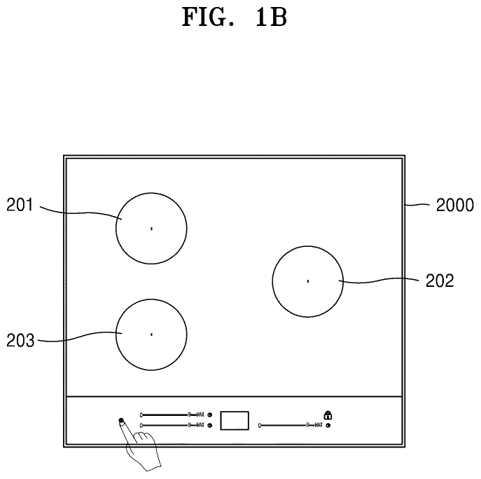

FIG. 1A is a diagram illustrating an induction heating apparatus according to an embodiment of the disclosure.

Referring to FIG. 1A, an induction heating apparatus 2000 according to an embodiment of the disclosure may include a plurality of heating zones 201, 202, and 203. Hereinafter, the induction heating apparatus 2000 may be referred to as an induction heating apparatus, an induction heating device, an induction cooking device, or simply a heating apparatus. All of the components shown in FIG. 1A are not essential components. The induction heating apparatus 2000 may be implemented with more or fewer components than those shown in FIG. 1A.

A cooking vessel 101 may be an instrument for heating contents inside the cooking vessel 101. The contents in the cooking vessel 101 may be liquids such as water, tea, coffee, soup, juice, wine, oil, etc., or solids such as butter, meat, vegetables, bread, rice, etc., but are not limited thereto.

According to an embodiment of the disclosure, the cooking vessel 101 may wirelessly receive power from the induction heating apparatus 2000 by using electromagnetic induction. Therefore, according to an embodiment of the disclosure, the cooking vessel 101 may not include a power line connected to a power outlet.

According to an embodiment of the disclosure, the type of cooking vessel 101 that receives power wirelessly from the induction heating apparatus 2000 may vary. The cooking vessel 101 may be a general induction heating (or IH) vessel including a magnetic material (hereinafter referred to as an IH vessel). The cooking vessel may have a magnetic field induced in the vessel (IH metal) itself.

The cooking vessel 101 may be a general IH vessel, such as a pot, a frying pan, or a steamer. The cooking appliance 1000 may include a cooker device. The cooker device may be an appliance into or from which a common IH vessel may be inserted or detached. According to an embodiment of the disclosure, the cooker device may be an appliance capable of automatically cooking contents according to a recipe. The cooker device may also be named a pot, a rice cooker, or a steamer depending on its use. For example, when an inner pot for cooking rice is inserted into the cooker device, the cooker device may be referred to as a rice cooker. Hereinafter, a cooker device may be referred to as a smart pan (or smart pot).

According to an embodiment of the disclosure, when the cooking vessel 101 includes a communication interface, the cooking vessel 101 may communicate with the induction heating apparatus 2000. The communication interface may include a short-range communication interface, a long-range communication interface, etc. The short-range communication interface may include, but is not limited to, a Bluetooth communication interface, a Bluetooth Low Energy (BLE) communication interface, a near field communication (NFC) interface, a wireless local area network (WLAN) (or Wi-Fi) communication interface, a ZigBee communication interface, an Infrared Data Association (IrDA) communication interface, a Wi-Fi Direct (WFD) communication interface, an ultra-wideband (UWB) communication interface, an Ant+ communication interface, etc. The long-range communication interface may be used to communicate with a server (not shown) when the cooking vessel 101 is remotely controlled by the server in an Internet of Things (IoT) environment. The long-range communication interface may include the Internet, a computer network (e.g., a LAN or a wide area network (WAN)), and a mobile communication interface. The mobile communication interface may include, but is not limited to, a 3rd generation (3G) module, a 4th generation (4G) module, a 5th generation (5G) module, a long-term evolution (LTE) module, a narrowband IoT (NB-IoT) module, an LTE machine (LTE-M) module, etc.

According to an embodiment of the disclosure, the cooking vessel 101 may transmit information to the server via the induction heating apparatus 2000. For example, the cooking vessel 101 may transmit, to the induction heating apparatus 2000, information obtained from the cooking vessel 101 itself (e.g., temperature information of contents therein, etc.) via short-range wireless communication (e.g., Bluetooth, BLE, etc.). In this case, the induction heating apparatus 2000 may transmit information obtained from the cooking vessel 101 to the server by accessing the server via the WLAN (Wi-Fi) communication interface or the long-range communication interface (e.g., the Internet). In addition, the server may provide the information obtained from the cooking vessel 101, which is received from the induction heating apparatus 2000, to a user via a mobile device (not shown) connected to the server. According to an embodiment of the disclosure, the induction heating apparatus 2000 may directly transmit the information obtained from the cooking vessel 101 to a user's mobile terminal via device-to-device (D2D) communication (e.g., WFD communication or BLE communication).

Moreover, according to an embodiment of the disclosure, the cooking vessel 106 may transmit information of the cooking vessel 106 (e.g., temperature information of contents therein, etc.) directly to the server via the communication interface (e.g., the WLAN (Wi-Fi) communication interface). In addition, the cooking appliance 1000 may directly transmit information obtained by the cooking appliance 1000 itself (e.g., temperature information of contents therein, etc.) to a user's mobile device via short-range wireless communication (e.g., Bluetooth, BLE, etc.) or D2D communication (e.g., WFD communication).

According to an embodiment of the disclosure, the induction heating apparatus 2000 may be an apparatus that wirelessly transmits power to the cooking vessel 101 located on a top plate of the induction heating apparatus 2000 by using electromagnetic induction. The induction heating apparatus 2000 may include a working coil that generates a magnetic field for inductively heating the cooking vessel 101. A working coil is a coil for producing a magnetic field through the flow of electricity, and may also be referred to as a heating coil throughout the disclosure.

Generating a magnetic field by using a heating coil may include transferring power by using a magnetic field induced in an IH metal (e.g., an iron component) via magnetic induction. For example, the induction heating apparatus 2000 may pass current through a heating coil to generate a magnetic field so that eddy currents may be generated in the cooking vessel 101.

According to an embodiment of the disclosure, the induction heating apparatus 2000 may include a plurality of heating coils. For example, when the top plate of the induction heating apparatus 2000 includes a plurality of cooking zones, the induction heating apparatus 2000 may include a plurality of heating coils respectively corresponding to the plurality of cooking zones. Furthermore, the induction heating apparatus 2000 may include a high-power cooking zone with a first heating coil provided on the inside and a second heating coil provided on the outside. The high-power cooking zone may include two or more heating coils.

According to an embodiment of the disclosure, the top plate of the induction heating apparatus 2000 may be formed of tempered glass such as ceramic glass so as not to be easily broken. In addition, the top plate of the induction heating apparatus 2000 may include a guide mark for guiding a cooking zone in which the cooking vessel 101 is to be located.

According to an embodiment of the disclosure, the induction heating apparatus 2000 may detect that the cooking vessel 101 including a magnetic material is placed on the top plate. For example, the induction heating apparatus 2000 may detect that the cooking vessel 101 is located on the top plate of the induction heating apparatus 2000, based on a change in a current value (inductance) of a heating coil due to the approach of the cooking vessel 101.

According to an embodiment of the disclosure, the induction heating apparatus 2000 may include a communication interface for communicating with an external device. For example, the induction heating apparatus 2000 may communicate with the cooking vessel 101 or the server via the communication interface. The communication interface may include a short-range communication interface (e.g., an NFC communication interface, a Bluetooth communication interface, a BLE communication interface, etc.), a mobile communication interface, etc.

According to an embodiment of the disclosure, the induction heating apparatus 2000 may detect, via the communication interface, the cooking vessel 101 located on the top plate. For example, the induction heating apparatus 2000 may detect the cooking vessel 101 by receiving a packet transmitted from the cooking vessel 101 located on the top plate via short-range wireless communication (e.g., BLE mesh network or Bluetooth).

According to an embodiment of the disclosure, the induction heating apparatus 2000 may detect whether the cooking vessel 101 is placed on the top plate of the induction heating apparatus 2000 via a vessel sensing coil (a vessel detection sensor) even when the cooking vessel 101 does not have a communication interface.

According to an embodiment of the disclosure, the induction heating apparatus 2000 may display information related to the cooking vessel 101 via a user interface. For example, when the cooking vessel 101 is detected, the induction heating apparatus 2000 may display identification information of the cooking vessel 101 and location information of the cooking vessel 101 on a display included in the user interface.

Referring to FIG. 1A, when the user places the cooking vessel 101 (e.g., a pot) on the top plate of the induction heating apparatus 2000, the induction heating apparatus 2000 may provide the user with identification information of the cooking vessel 101 (e.g., a pot) and location information of the cooking vessel 101 (e.g., located on the right heating zone) on a display 2411 as an output interface.

FIG. 1B is a diagram illustrating an induction heating apparatus according to an embodiment of the disclosure.

FIG. 1B is a top view of the induction heating apparatus 2000 according to FIG. 1A on which a cooking vessel is not placed. The induction heating apparatus 2000 of FIG. 1B may include a plurality of heating zones 201, 202, and 203, and thus may heat a plurality of cooking vessels simultaneously. When the induction heating apparatus 2000 heats a plurality of cooking vessels simultaneously, a heating coil corresponding to each heating zone may be operated. The induction heating apparatus 2000 shown in FIGS. 1A and 1B is an induction heating apparatus having a heating zone corresponding to a cooking vessel.

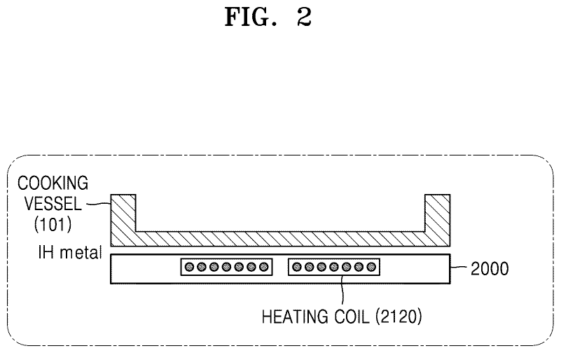

FIG. 2 is a cross-sectional view of a cooking vessel placed on an induction heating apparatus, according to an embodiment of the disclosure.

Referring to FIG. 2, the cooking vessel 101 may include a magnetic material (e.g., an IH metal) in which a magnetic field may be induced.

The cooking vessel 101 may be inductively heated by the induction heating apparatus 2000, and may be any of various types of vessels including a magnetic material. Induction heating or IH is a method of heating an IH metal using an electromagnetic induction phenomenon. For example, when an alternating current (AC) is supplied to a heating coil 2120 of the induction heating apparatus 2000, a time-varying magnetic field is induced inside the heating coil 2120. The magnetic field generated by the heating coil 2120 passes through a bottom surface of the cooking vessel 101. When the time-varying magnetic field passes through an IH metal (e.g., iron, nickel steel, or various types of alloys) included in the bottom surface of cooking vessel 101, a current circulating around the magnetic field is generated in the IH metal. The circulating current is called an eddy current, and a phenomenon in which current is induced by a time-varying magnetic field is called an electromagnetic induction phenomenon. Heat is generated in the bottom surface of the cooking vessel 101 due to resistance of the IH metal (e.g., iron) and the eddy current. The generated heat may heat the contents in the cooking vessel 101.

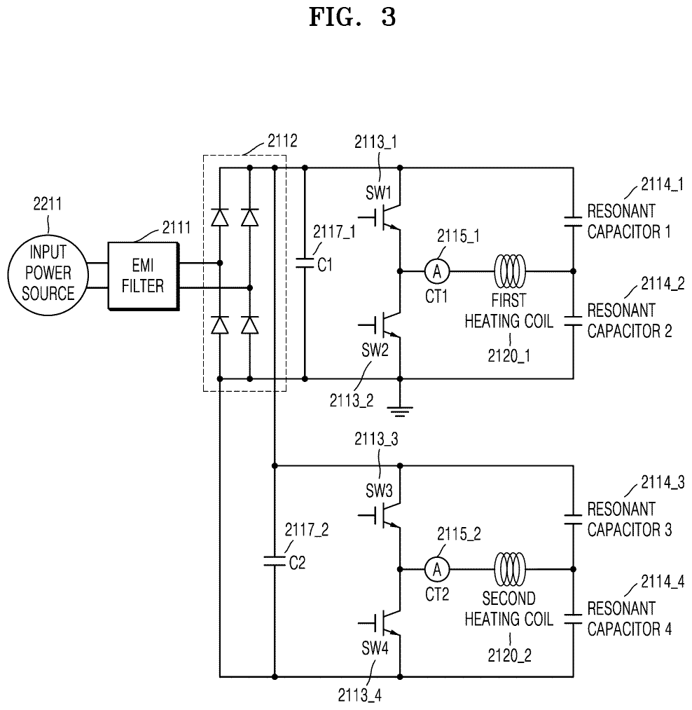

FIG. 3 is a circuit diagram of an inverter of an induction heating apparatus for operating a plurality of heating coils, according to an embodiment of the disclosure.

Referring to FIG. 3, an input power source 2211 is an alternating current (AC) power source. An AC voltage from the input power source 2211 passes through an electromagnetic interference (EMI) filter 2111 and is rectified by a rectifier circuit 2112. The rectifier circuit 2112 may use a diode as an element for converting the AC voltage to a DC voltage. A diode may be used as the element of the rectifier circuit 2112, but a thyristor or other types of switching elements may be used. When the AC voltage is converted to a DC voltage via the rectifier circuit 2112, the DC voltage may be smoothed by DC link capacitors 2117_1 and 2117_2.

FIG. 3 illustrates two resonant circuits assuming that there are two heating coils (i.e., a first heating coil 2120_1 and a second heating coil 2120_2), but when there are three heating zones and three heating coils are required, another resonant circuit may be added.

The DC voltage smoothed by the DC link capacitor 2117_1 generates a magnetic field in the first heating coil 2120_1 due to resonance between the first heating coil 2120_1 and a resonant capacitor 1 2114_1 and a resonant capacitor 2 2114_2, which is triggered by a switching operation of two switching elements, i.e., a first switch SW1 2113_1 and a second switch SW2 2113_2. The magnetic field generated in the first heating coil 2120_1 generates an eddy current in a cooking vessel placed on top of the first heating coil 2120_1, thereby heating the contents in the cooking vessel. CT1 2115_1 is a current sensor for detecting a current flowing in the first heating coil 2120_1.

Similarly, the DC voltage smoothed by the DC link capacitor 2117_2 at the bottom generates a magnetic field in the second heating coil 2120_2 due to resonance between the second heating coil 2120_2 and a resonant capacitor 3 2113_3 and a resonant capacitor 4 2113_4, which is triggered by a switching operation of two switching elements, i.e., a third switch SW3 2113_3 and a fourth switch SW4 2113_4. The magnetic field generated in the second heating coil 2120_2 generates an eddy current in a cooking vessel placed on top of the second heating coil 2120_2, thereby heating the contents in the cooking vessel. CT2 2115_2 is a current sensor for detecting a current flowing in the second heating coil 2120_2.

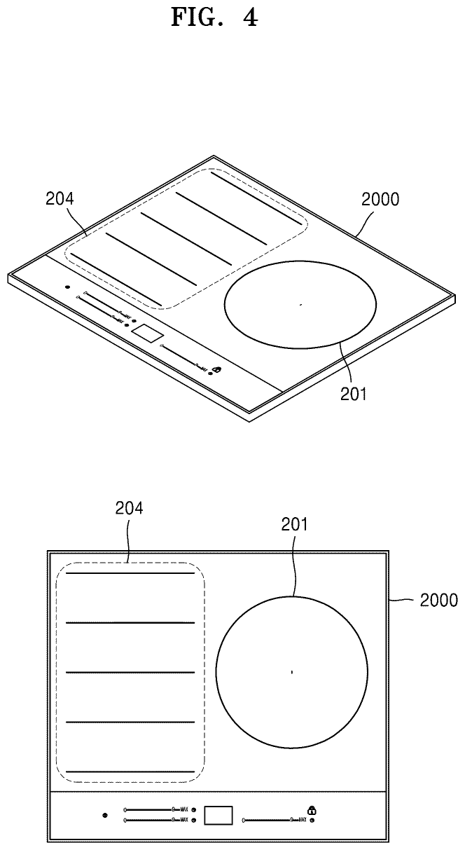

FIG. 4 illustrates an induction heating apparatus using a quadrilateral heating coil, according to an embodiment of the disclosure.

Referring to FIG. 4, according to an embodiment of the disclosure, an induction heating apparatus 2000 may include a first heating zone 201 having a circular shape and operated by a circular heating coil and a quadrilateral heating zone 204 formed by quadrilateral heating coils. The quadrilateral may be a rectangle, and the heating coil on a bottom surface of the quadrilateral heating zone 204 may be a plurality of rectangular heating coils. Alternatively, a plurality of circular heating coils may be used as the heating coil on the bottom surface of the quadrilateral heating zone 204.

The use of a quadrilateral heating coil in the induction heating apparatus 2000 has the advantage of eliminating a non-cooking zone, for example, when a square shaped pot is placed on it. Furthermore, when a user of the induction heating apparatus 2000 places a cooking vessel anywhere on the quadrilateral heating zone 204, the induction heating apparatus 2000 may recognize the cooking vessel and operate the quadrilateral heating coil necessary for heating the cooking vessel, thereby heating the contents in the cooking vessel. Although FIG. 4 illustrates an example in which the induction heating apparatus 2000 may include both the first heating zone 201 that is a circular heating zone and the quadrilateral heating zone 204, according to an embodiment of the disclosure, the induction heating apparatus 2000 may include only a quadrilateral heating zone. In this case, the induction heating apparatus 2000 is referred to as an Anyplace induction heating apparatus because when a cooking vessel is placed anywhere thereon, the induction heating apparatus 2000 detects the cooking vessel and operates a corresponding heating coil.

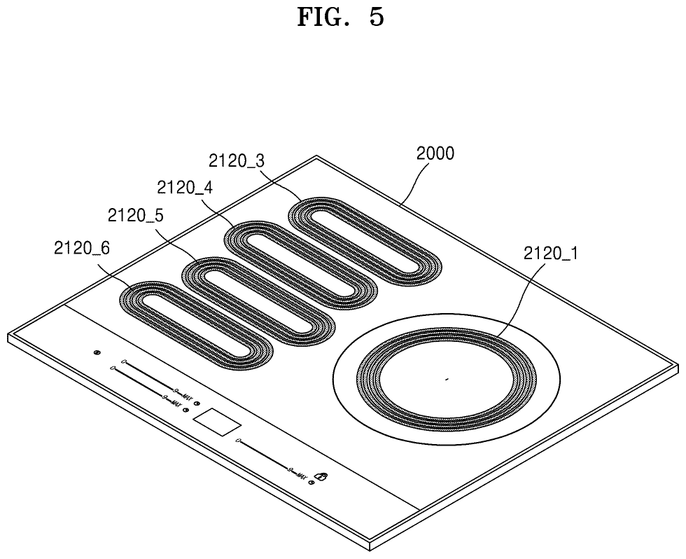

FIG. 5 illustrates an induction heating apparatus together with heating coils, according to an embodiment of the disclosure.

FIG. 5 illustrates the appearance of heating coils wound inside the induction heating apparatus 2000 beside each other, which corresponds to an exterior of the induction heating apparatus 2000. The wound heating coils are not actually visible from the outside. As illustrated in FIG. 5, according to an embodiment of the disclosure, in the induction heating apparatus 2000, four quadrilateral heating coils 2120_3, 2120_4, 2120_5, and 2120_6 corresponding to the quadrilateral heating zone 204 are sequentially wound from the top of the induction heating apparatus 2000. However, this is only an example, and the number of the quadrilateral heating coils 2120_3, 2120_4, 2120_5, and 2120_6 corresponding to the quadrilateral heating zone 204 may be four or more, or less than four. Furthermore, when the induction heating apparatus 2000 is an Anyplace induction heating apparatus as described above, a first heating coil 2120_1 may also be replaced with one or more quadrilateral heating coils.

As previously seen in FIG. 1, the first heating coil 2120_1 having a circular shape corresponding to the first heating zone 201 that is a circular heating zone is wound on the right side of the top plate of the induction heating apparatus 2000 according to FIG. 5.

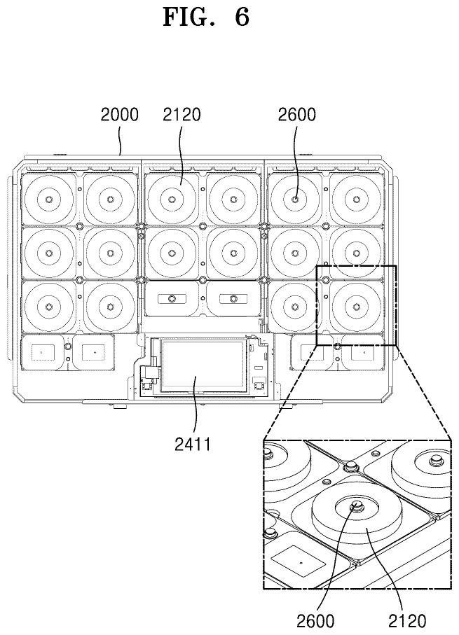

FIG. 6 illustrates heating coils wound in an Anyplace induction heating apparatus.

Referring to FIG. 6, each heating coil 2120 of the induction heating apparatus 2000 is formed by winding a litz wire in a round shape and arranged tightly under the top plate of the induction heating apparatus 2000, so that there is no heating gap wherever the cooking vessel 101 is placed. The induction heating apparatus 2000 illustrated in FIG. 6 may be referred to as an Anyplace induction heating apparatus. In an Anyplace induction heating apparatus as shown in FIG. 6, heating coils are arranged so that there are no dead spots between a plurality of heating coils. In addition, at least one vessel sensing coil may also be arranged where the heating coils are arranged.

In an embodiment of the disclosure, a temperature sensor 2600 for sensing a temperature of the cooking vessel 101 may be disposed in a center of each heating coil 2120.

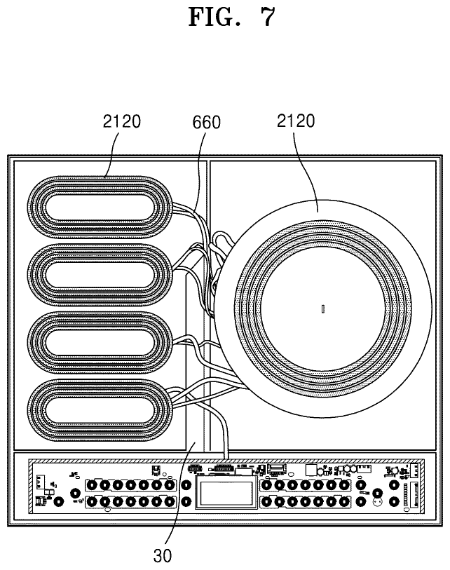

FIG. 7 illustrates the appearance of wound heating coils.

FIG. 7 shows that the heating coils 2120 are connected to an inverter board 30 via wires 660. The inverter board 30 may include an inverter connector to which the wires 660 may be connected. The heating coils 2120 may be fabricated by wrapping litz wires in a round shape, or in the case of the quadrilateral heating coils 2120_3, 2120_4, 2120_5, and 2120_6, may be fabricated by wrapping litz wires in a quadrilateral shape. A conductor wire may be used as a litz wire. A copper wire is widely used as a litz wire. An end of each of the heating coils 2120 may be connected to the inverter board 30 via the wire 660. When the heating coils 2120 are all fabricated using litz wires, then in the Anyplace induction heating apparatus where the cooking vessel 101 may be freely placed anywhere on a top plate, each of the heating coils 2120 needs to be fabricated in a small size and arranged closely because there may be dead spots between the plurality of heating coils 2120. Furthermore, when the heating coil 2120 is fabricated using a litz wire, the litz wire needs to be wound through manual or semi-manual work, so the work process is time consuming and there is a possibility that the product of the heating coil 2120 may not be consistent. When a product of a heating coil is not consistent, inductance determined by the heating coil is not constant. Furthermore, when a heating coil made of a litz wire is used, as shown in FIG. 7, the numerous wires 660 connecting the heating coils 2120 to the inverter board 30 have to be used, which not only complicates the work process but also makes the assembly process inefficient and increases the manufacturing costs. In addition, wire damage may occur because long wires become tangled with each other. This may cause problems such as poor wire quality and poor quality of the induction heating apparatus 2000.

In recent years, the induction heating apparatus 2000 and the components included in the induction heating apparatus 2000 have been evolved to become smaller, slimmer, and thinner, and in line with this trend, the issue of reducing heat generated in circuit components has also arisen. Various cooling structures are being developed to solve the heat generated in circuit components, but the more the heating coils, the more complicated the connections between circuit components, the narrower the space for arrangement of heating coils, wires connected to the heating coils, and an inverter board, and the more difficult it is to design the circuit components and cooling structures.

Therefore, in order to solve these problems, according to an embodiment of the disclosure, a plurality of heating coils of the induction heating apparatus 2000 may be fabricated by printing the heating coils on a heating coil board rather than winding them with litz wires. Also, the heating coil board may be formed by pressing a laminated board in which a plurality of heating coil pattern layers with printed heating coils are stacked. Furthermore, the laminated board may include an insulating material for insulation with each heating coil pattern layer composed of printed heating coils.

The heating coil board produced in this way may also be connected to the inverter board 30 via the wire 660, but may be connected thereto by using a board-to-board connection via a fixed vertical connector mounted on each board. According to an embodiment of the disclosure, the heating coil board may be connected to an inverter board or an intermediate board via connectors.

The heating coils 2120 printed in the heating coil board are driven by the inverter to resonate with a resonant capacitor (not shown) on the inverter board 30, thereby heating the cooking vessel 101. The inverter board 30 may also be referred to as an inverter printed board assembly (PBA).

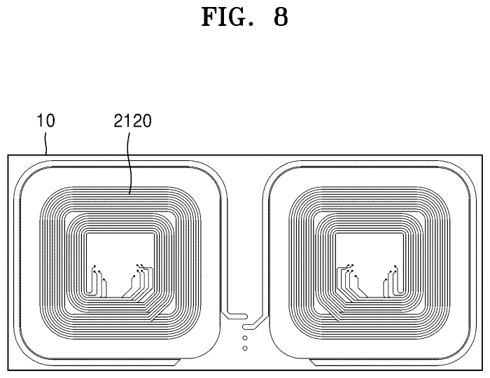

FIG. 8 illustrates a heating coil board of an induction heating apparatus, according to an embodiment of the disclosure.

Referring to FIG. 8, a heating coil board 10 with heating coils 2120 patterned onto a board may be shown.

The heating coils 2120 may include conductors printed on the heating coil board 10. In an embodiment of the disclosure, a heating coil board having two or more heating coil pattern layers stacked together may be employed as the heating coil board 10. In order to implement a high power induction heating apparatus (having a maximum power exceeding 3 kilowatts (KW) by using the heating coil board 10 with two or more heating coil pattern layers stacked, a thickness of one layer of copper (a thickness of a coil pattern) needs to be about 500 micrometers (μm). However, when the thickness of a coil pattern is increased, the influence of skin effect may increase, resulting in large coil losses. In order to achieve a high power while reducing the skin effect, a method of securing current capacity by reducing the thickness and width of the heating coil pattern and connecting a plurality of heating coil patterns in parallel may be considered. In this case, the number of interlayer connections for connecting the plurality of heating coils in parallel may increase, and heating coil losses due to the length of wiring may also increase. Therefore, according to an embodiment of the disclosure, a laminated board in which multiple heating coil pattern layers are stacked and the heating coil board 10 formed by pressing the laminated board may be employed, which may reduce the number of interlayer connections while reducing heating coil losses. Here, the multiple layers may include four or more layers. In an embodiment of the disclosure, a heating coil pattern layer may be provided on the heating coil board 10 in the form of a sheet. For example, the heating coils 2120 may be in the form of a PCB formed on the heating coil board 10 through a patterning process using photoresist or the like. In an embodiment of the disclosure, each of the plurality of heating coils 2120 may have the same shape and size. In an embodiment of the disclosure, the plurality of heating coils 2120 need not all have the same shape and size. For example, at least one of the plurality of heating coils 2120 may be different from other heating coils in at least one of a shape or a size.

The heating coil board 10 may replace positions of a plurality of heating coils in the induction heating apparatus 2000 as shown in FIG. 6. In this way, the Anyplace induction heating apparatus 2000 formed by the heating coil board 10 may be fabricated.

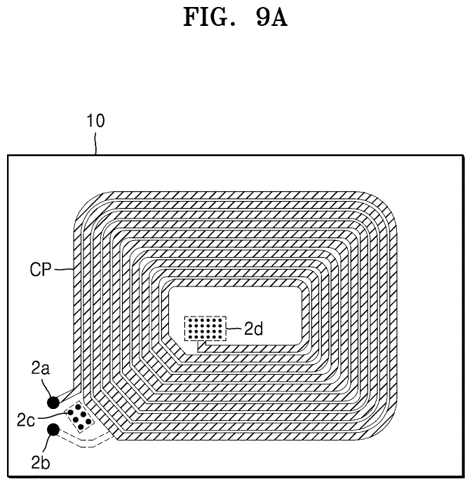

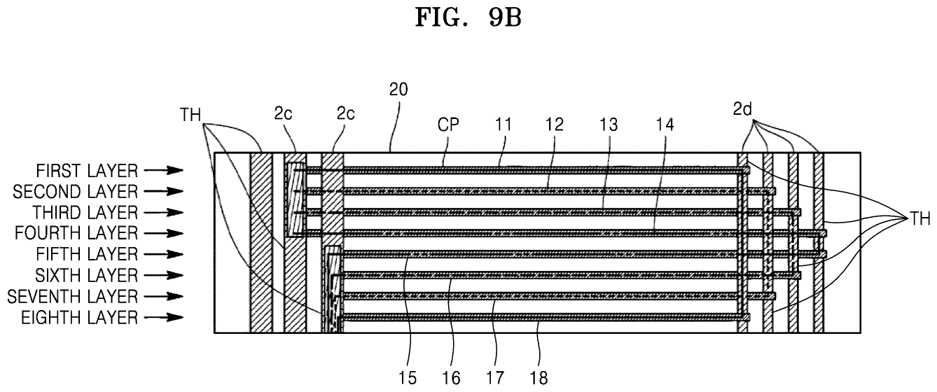

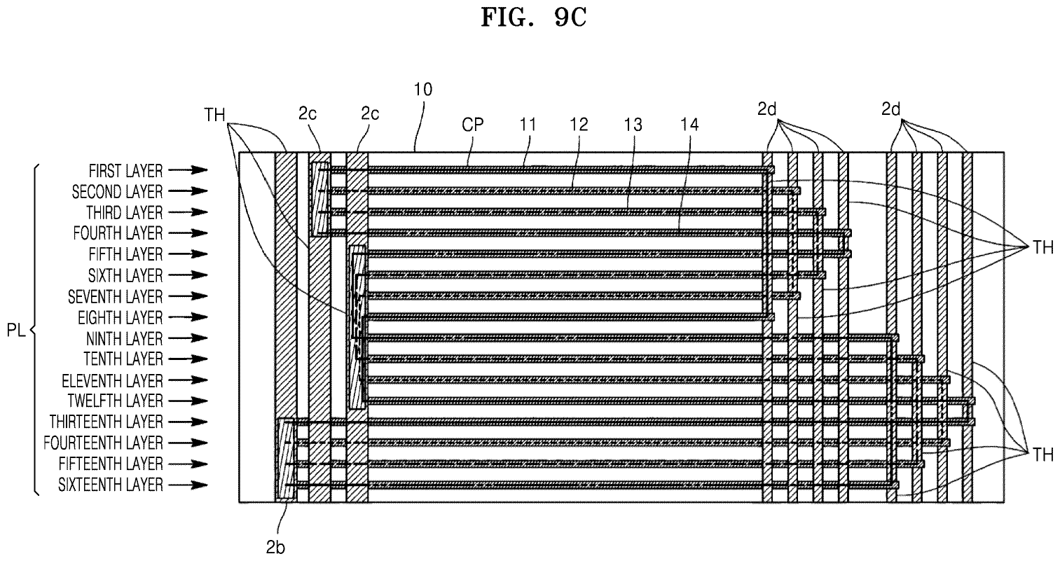

FIG. 9A is a plan view of a heating coil board according to an embodiment of the disclosure.

Referring to FIG. 9A, the heating coil board 10 may be a printed circuit board (PCB) formed by stacking four or more heating coil pattern layers PL having coil patterns CP formed therein. An insulating layer may be inserted between the heating coil pattern layers. In the induction heating apparatus 2000 having the heating coil board 10, because the heating coil board 10 has a multi-layer structure with four or more layers, a thickness of one layer of a heating coil (a copper thickness) may be reduced to 70 μm or less and a pattern width may be made smaller, thereby reducing the influence of the skin effect and thus reducing coil losses. However, this is only an embodiment of the disclosure, and the heating coil board 10 may have a structure of five or more layers which are more than 4 layers.

In the heating coil board 10, one or more coil patterns CP are formed in each of the plurality of heating coil pattern layers (also hereinafter, pattern layers) PL. For example, a coil pattern CP may be a spiral pattern. In an embodiment of the disclosure, the coil pattern CP may be formed by a plurality of coil elements that are approximately rectangular when viewed from the plane, as shown in FIG. 8. In an embodiment of the disclosure, the coil pattern CP may be formed by a plurality of coil elements that are circular when viewed from the plane. A shape of the coil elements forming the coil pattern CP is not limited to the above-described shape. The heating coil board 10 may include a plurality of serial pattern groups. The plurality of serial pattern groups may be connected in parallel to each other. Each of the plurality of serial pattern groups may include a plurality of coil patterns CP connected in series. The plurality of serial pattern groups may be formed such that coil patterns CP formed on adjacent pattern layers among the plurality of pattern layers PL are connected in parallel to each other. As a result, coils formed in the plurality of pattern layers PL may form a parallel connection relationship, and a large current capacity may be secured while reducing heating coil losses. The plurality of coil patterns CP forming each of the plurality of serial pattern groups may be formed in four or more pattern layers PL. At least one of the plurality of serial pattern groups may have a different combination of a plurality of pattern layers PL than the rest of the plurality of serial pattern groups. Due to these configurations, a wiring structure may be simplified and thus the number of interlayer connections may be reduced, thereby reducing power loss. In other words, an impedance gap between the serial pattern groups connected in parallel may be reduced due to mutual impedance in each pattern layer, thereby maintaining efficiency characteristics that are theoretically equivalent to those of a full-layer series connection structure. Furthermore, because the number of interlayer connections is reduced compared to the full-layer series connection structure, interlayer wiring resistance is lowered, enabling a lower loss design than in the full-layer series connection structure. The plurality of serial pattern groups may include at least two serial pattern groups having the same combination of pattern layers. Thereby, the number of interlayer connections may be reduced.

In an embodiment of the disclosure, the heating coil board 10 may have two terminals (an input terminal 2a and an output terminal 2b) formed on an outer periphery of a coil pattern CP for parallel connection between a plurality of series pattern groups included in each stacked layer. Furthermore, electrical connection between pattern layers may be made by a conductor (a through-hole TH or via hole) penetrating the heating coil board 10. The through-hole TH penetrates all of the pattern layers PL and allows electrical connections between layers.

Furthermore, according to an embodiment of the disclosure, in the heating coil board 10, the coil patterns CP may be connected so that an input terminal side is at an uppermost layer among the plurality of pattern layers PL, and an output terminal side is at a lowermost layer among the plurality of pattern layers PL. According to this configuration, an electronic sensor may be mounted on an upper layer when forming multi-layer coil patterns CP, and the weak electric sensor may be easily formed in a thin film structure.

FIG. 9B is a cross-sectional view illustrating interlayer connections in a heating coil board, according to an embodiment of the disclosure.

FIG. 9B is a cross-sectional view illustrating interlayer connections in a heating coil board 10 having an eight-layer structure, according to an embodiment of the disclosure. Referring to FIG. 9B, the heating coil board 10 may be a PCB formed by stacking four or more pattern layers PL having coil patterns CP formed therein. An insulating layer with two or more pre-impregnated material (prepreg) insulation layers stacked may be included between pattern layers.

According to an embodiment of the disclosure, FIG. 9B shows the heating coil board 10 formed by stacking eight heating coil pattern layers PL (first to eighth layers). According to an embodiment of the disclosure, the heating coil board 10 includes four heating coil pattern layers 11, 12, 13, and 14 and another four heating coil pattern layers 15, 16, 17, and 18. In an embodiment of the disclosure, each of the four heating coil pattern layers 11, 12, 13, and 14 may include four coil patterns CP connected in series. The four heating coil pattern layers 11, 12, 13, and 14 are connected in parallel to each other via a through-hole TH 2c.

In FIG. 9B, the plurality of heating coil pattern layers 11, 12, 13, 14, 15, 16, 17, and 18 are respectively referred to as a first heating coil pattern layer 11, a second heating coil pattern layer 12, a third heating coil pattern layer 13, a fourth heating coil pattern layer 14, a fifth heating coil pattern layer 15, a sixth heating coil pattern layer 16, a seventh heating coil pattern layer 17, and an eighth heating coil pattern layer 18 in sequential order from the top.

Referring to FIG. 9B, the first heating coil pattern layer 11 may be connected in series with the eighth heating coil pattern layer 18 formed at the eighth layer via a through-hole TH 2d. The second heating coil pattern layer 12 may be connected in series with the seventh heating coil pattern layer 17 formed at the seventh layer via a through-hole TH 2d. The third heating coil pattern layer 13 may be connected in series with the sixth heating coil pattern layer 16 formed at the sixth layer via a through-hole TH 2d. The fourth heating coil pattern layer 14 at the fourth layer may be connected in series with the fifth heating coil pattern layer 15 formed at the fifth layer via a through-hole TH 2d.

In this way, the first to fourth heating coil pattern layers 11, 12, 13, and 14 shown in FIGS. 9A and 9B respectively have different combinations of pattern layers connected in series. When the first to fourth heating coil pattern layers 11, 12, 13, and 14 are connected in parallel, coil patterns CP formed in different pattern layers may be connected in parallel.

Furthermore, according to an embodiment of the disclosure, in the heating coil board 10, the coil patterns CP may be connected so that an input terminal side is at an uppermost layer among the plurality of heating coil pattern layers PL, and an output terminal side is at a lowermost layer among the plurality of heating coil pattern layers PL. According to this configuration, when the plurality of heating coil pattern layers PL are formed and a weak electric sensor is mounted on an upper layer, it is easy to form the weak electric sensor in a thin film structure. The weak electric sensor may include a vessel sensing coil.

The multi-layer structure of the heating coil board 10 is not limited to the eight-layer structure described above.

FIG. 9C is a cross-sectional view illustrating a heating coil board having a 16-layer structure and a series-parallel connection in the heating coil board, according to an embodiment of the disclosure.

A connection structure illustrated in the cross-sectional view of FIG. 9C is the same as that illustrated in FIG. 9B in terms of a stacking method and in that a plurality of coil patterns CP connected in series may be provided in one heating coil pattern layer.

A heating coil board 10 may include a plurality of serial pattern groups. The plurality of serial pattern groups may be connected in parallel to each other. Each of the plurality of serial pattern groups may include a plurality of coil patterns CP connected in series. The plurality of serial pattern groups may be formed such that adjacent heating coil pattern layers among the plurality of heating coil pattern layers PL are connected in parallel to each other. As a result, coils formed in the plurality of heating coil pattern layers PL may form a parallel connection relationship, and a large current capacity may be secured. The plurality of coil patterns CP forming each of the plurality of serial pattern groups may be formed in four or more pattern layers PL. At least one of the plurality of serial pattern groups may have a different combination of a plurality of heating coil pattern layers than the rest of the plurality of serial pattern groups. Due to these configurations, a wiring structure may be simplified and thus the number of interlayer connections may be reduced, which may accordingly reduce power loss. That is, an impedance gap between the serial pattern groups connected in parallel may be reduced due to mutual impedance in each heating coil pattern layer, thereby maintaining efficiency characteristics that are theoretically equivalent to those of a full-layer series connection structure. Furthermore, because the number of interlayer connections is reduced compared to the full-layer series connection structure, interlayer wiring resistance is lowered, enabling a lower loss design than in the full-layer series connection structure. The plurality of serial pattern groups may include at least two serial pattern groups having the same combination of a plurality of heating coil pattern layers. Thereby, the number of interlayer connections may be reduced.

According to an embodiment of the disclosure, FIG. 9C shows the heating coil board 10 formed by stacking sixteen heating coil pattern layers PL (first to sixteenth layers). In an embodiment of the disclosure, the heating coil board 10 includes four heating coil pattern layers, i.e., first to fourth heating coil pattern layers 11, 12, 13, and 14. According to an embodiment of the disclosure, each of the first to fourth heating coil pattern layers 11, 12, 13, and 14 may include four coil patterns CP connected in series. The first to fourth heating coil pattern layers 11, 12, 13, and 14 are connected in parallel to each other via a through-hole TH 2c.

For example, referring to FIG. 9C, the first heating coil pattern layer 11 at the first layer may be connected in series with a heating coil pattern layer formed at the eighth layer. The second heating coil pattern layer 12 at the second layer may be connected in series with heating coil pattern layers formed at the seventh, tenth, and fifteenth layers. The third heating coil pattern layer 13 at the third layer may be connected in series with heating coil pattern layers formed at the sixth, eleventh, and fourteenth layers. The fourth heating coil pattern layer 14 at the fourth layer may be connected in series with heating coil pattern layers formed at the fifth, twelfth, and thirteenth layers.

In this way, the first to fourth heating coil pattern layers 11, 12, 13, and 14 shown in FIG. 9C respectively have different combinations of heating coil pattern layers connected in series. When the first to fourth heating coil pattern layers 11, 12, 13, and 14 are connected in parallel, coil patterns CP formed in different pattern layers may be connected in parallel.

According to an embodiment of the disclosure, electrical connection between heating coil pattern layers is formed by a conductor (a through-hole TH) penetrating the heating coil board 10. The through-hole TH is formed through all of the heating coil pattern layers PL. Four coil patterns CP forming each of the first to fourth heating coil pattern layers 11, 12, 13, 14 may be connected in series by one intermediate terminal 2c formed of a conductor installed on an outer periphery of a coil pattern CP and a plurality of connection terminals 2d formed of conductors installed on an inner periphery of the coil pattern CP.

Furthermore, in the heating coil board 10 of the embodiment of the disclosure, the coil patterns CP may be connected so that an input terminal side is at an uppermost layer among the plurality of heating coil pattern layers PL, and an output terminal side is at a lowermost layer among the plurality of heating coil pattern layers PL. According to this configuration, when the plurality of heating coil pattern layers PL are formed and a weak electric sensor is mounted on an upper layer, it is easy to form the weak electric sensor in a thin film structure. According to an embodiment of the disclosure, the weak electric sensor may include a vessel sensing coil as a vessel detection sensor.

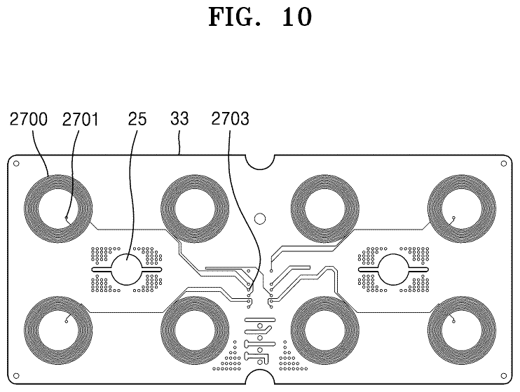

FIG. 10 illustrates a pattern layer including a vessel sensing coil, according to an embodiment of the disclosure.

Referring to FIG. 10, a vessel sensing coil layer 33 including vessel sensing coils 2700 in the heating coil board 10 is shown.

The vessel sensing coil layer 33 of FIG. 10 includes the eight vessel sensing coils 2700 in a pattern. Furthermore, according to an embodiment of the disclosure, the vessel sensing coil layer 33 includes a hole 25 through which a temperature sensor capable of detecting the temperature of a cooking vessel may penetrate. In some cases, the vessel sensing coil layer 33 may not include the hole 25 through which the temperature sensor may penetrate. In the vessel sensing coil layer 33 of FIG. 10, the pattern of the vessel sensing coils 2700 may have a circular shape and may be provided in a plane space that does not vertically overlap as much as possible with heating coils patterned in other layers. The reason why the vessel sensing coils 2700 and the heating coils should not overlap vertically as much as possible is due to a high power level of the heating coils. The heating coils with a high power level may affect a sensing operation of the vessel sensing coils 2700 with a relatively low power level. Thus, in an embodiment of the disclosure, the vessel sensing coils 2700 may be printed as close to corners as possible on diagonal lines of a board on which the vessel sensing coils 2700 are to be printed, and the heating coils may be printed in a center of a board on which the heating coils are to be printed.

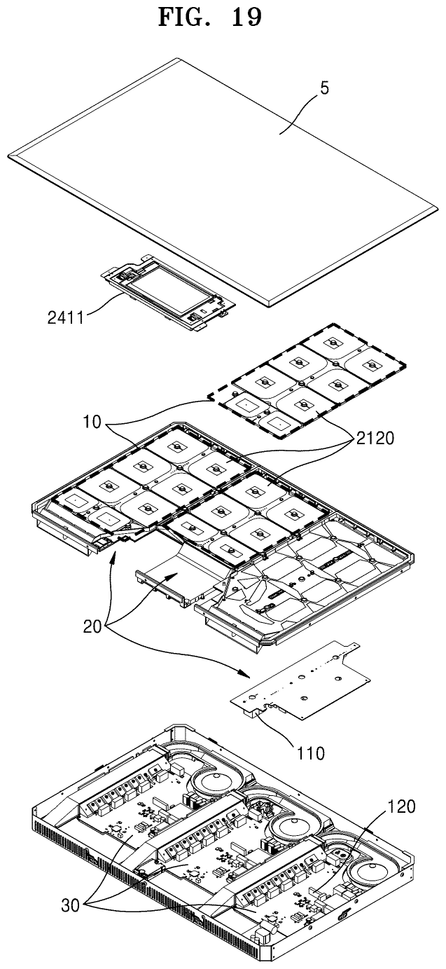

The vessel sensing coil 2700 may include a first end 2701 that descends through a through-hole or via hole in the middle of a circle in which the vessel sensing coil 33 is patterned to the lowermost layer of the heating coil board 10, and a second end 2703 for connecting to a connector provided in the vessel sensing coil layer 33. The induction heating apparatus 2000 may detect whether there is a cooking vessel on a top plate (5 of FIG. 19) of the induction heating apparatus 2000, based on a change in inductance measured through the first end 2701 and the second end 2703.

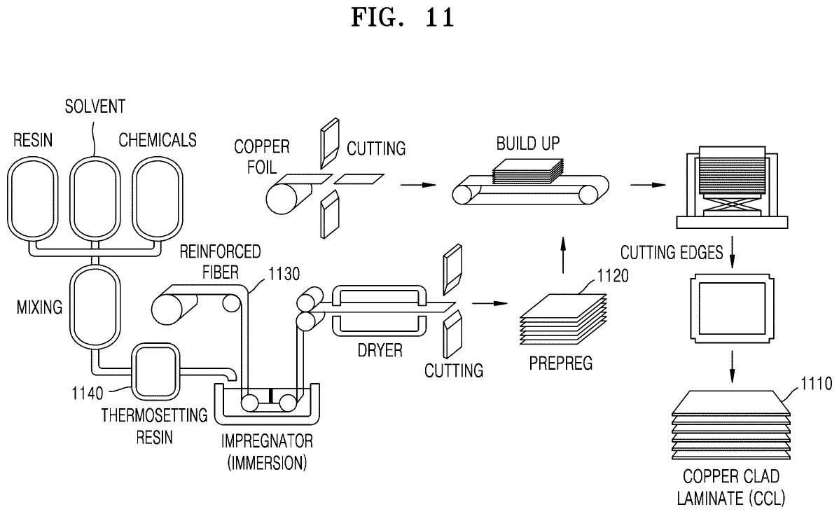

FIG. 11 illustrates a process of manufacturing a heating coil board of an induction heating apparatus, according to an embodiment of the disclosure.

FIG. 11 illustrates a final production process of a copper clad laminate (CCL) 1110. The CCL 1110 is a PCB base plate consisting of a plurality of heating coil pattern layers laminated together. The CCL 1110 may be produced by bonding copper foil to one or both sides of a PCB core. The CCL 1110 is formed by laminating the copper foil onto a prepreg 1120.

The prepreg 1120 is a sheet-shaped resin product in which a matrix is pre-impregnated into a reinforced fiber 1130, and is semi-cured by infiltrating thermosetting resin 1140 into the reinforced fiber 1130. The prepreg 1120 is not only an insulating material but is also used as an adhesive that bonds each heating coil pattern layer.

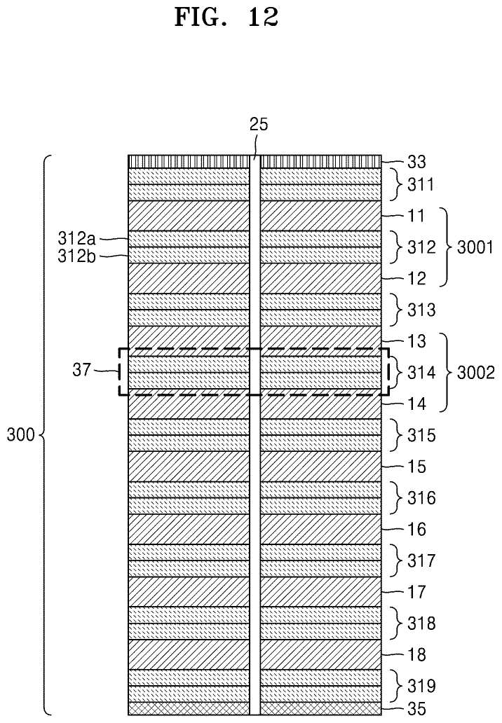

FIG. 12 illustrates layers in a heating coil board, according to an embodiment of the disclosure.

Referring to FIG. 12, according to an embodiment of the disclosure, a laminated board 300 may include a plurality of (eight) heating coil pattern layers, i.e., first to eighth heating coil pattern layers 11, 12, 13, 14, 15, 16, 17, and 18, and a plurality of (nine) insulating layers 311, 312, 313, 314, 315, 316, 317, 318, and 319. One insulating layer 312 consists of, for example, two prepreg insulation layers 312a and 312b. The heating coil board 10 is produced by hot-pressing the laminated board 300.

In FIG. 12, a PCB base plate used to fabricate a board forming one heating coil pattern layer (e.g., the first heating coil pattern layer 11) has a size of 1020 (mm)×1200 (mm) or 1020 (mm)×1020 (mm). When manufacturing a board by printing a heating coil pattern on a PCB base plate, a thickness of copper patterned as a conductor and a width of the heating coil pattern need to be narrowed in order to supply high power while reducing the skin effect. At the same time, a current capacity may be secured by connecting in parallel the plurality of heating coil pattern layers, i.e., the first to eighth heating coil pattern layers 11, 12, 13, 14, 15, 16, 17, and 18. However, in order to connect the plurality of heating coil pattern layers in parallel, the number of interlayer connections increases, and coil losses due to the length of the wiring also increase. Some of the plurality of heating coil pattern layers may be provided with a plurality of serial patterns connected in series to reduce the number of interlayer connections while reducing coil losses. In addition, these plurality of serial patterns may be connected in parallel to each other. In an embodiment of the disclosure, it is desirable that at least one serial pattern is stacked in four or more layers.

According to an embodiment of the disclosure, the upper four heating coil pattern layers, i.e., the first to fourth heating coil pattern layers 11, 12, 13, and 14, among the plurality of heating coil pattern layers may be electrically connected in parallel. Furthermore, the lower four heating coil pattern layers, i.e., the fifth to eighth heating coil pattern layers 15, 16, 17, and 18, among the plurality of heating coil pattern layers may be electrically connected in parallel. Although ‘upper’ and ‘lower’ used herein are relative terms, a side of the plurality of heating coil pattern layers, which is closer to the top plate of the induction heating apparatus 2000, may be referred to as ‘upper’.

The upper four heating coil pattern layers electrically connected in parallel to each other may be connected in series with the lower four heating coil pattern layers electrically connected in parallel. The series connections between heating coil pattern layers may be made between the first heating coil pattern layer 11 and the eighth heating coil pattern layer 18, the second heating coil pattern layer 12 and the seventh heating coil pattern layer 17, the third heating coil pattern layer 13 and the sixth heating coil pattern layer 16, and the fourth heating coil pattern layer 14 and the fifth heating coil pattern layer 15. A detailed description thereof has already been provided with reference to FIG. 9B.

However, this is only an embodiment of the disclosure, and when the heating coil pattern layer is composed of only the first heating coil pattern layer 11 to the fourth heating coil pattern layer 14, the first heating coil pattern layer 11 and the second heating coil pattern layer 12 may be electrically connected in parallel with each other, and the third heating coil pattern layer 13 and the fourth heating coil pattern layer 14 may be electrically connected in parallel with each other. Furthermore, the first heating coil pattern layer 11 and the fourth heating coil pattern layer 14 may be electrically connected in series, and the second heating coil pattern layer 12 and the third heating coil pattern layer 13 may be electrically connected in series.

In an embodiment of the disclosure, each of the plurality of heating coil pattern layers may have a thickness of about 60 μm to about 82 μm.

In an embodiment of the disclosure, a thickness of the heating coil board 10 formed by hot-pressing the laminated board 300 including a vessel sensing coil layer 33, a signal layer 35 for connector connection, and the plurality of heating coil pattern layers composed of the eight layers may be 3.3 mm or less. However, this is only an embodiment of the disclosure, and the thickness of the heating coil board 10 formed by pressing the laminated board 300 may be between about 2.5 mm and about 4.0 mm.

When a manufacturer of the induction heating apparatus 2000 orders CCLs, each CCL may be fabricated in the form of two heating coil pattern layers with an insulating layer therebetween. In this case, insulating layers may be inserted between a plurality of CCLs to form the laminated board 300. In this case, each insulating layer may be formed by stacking two prepreg insulation layers.

Referring to FIG. 12, a first CCL 3001 may be composed of the first heating coil pattern layer 11, the insulating layer 312, and the second heating coil pattern layer 12. A second CCL 3002 may be composed of the third heating coil pattern layer 13, the insulating layer 314, and the fourth heating coil pattern layer 14. When the manufacturer of the induction heating apparatus 2000 obtains the ordered CCLs, the CCLs and the insulating layers therebetween may be laminated together to form the laminated board 300. For example, the insulating layer 313 may be inserted between the first CCL 3001 and the second CCL 3002. The insulating layer 313 may be formed by stacking two prepreg insulation layers.

When the laminated board 300 is finally hot-pressed, the CCLs are barely pressed because they have been already pressed, and instead, an insulating layer between the CCLs (e.g., the insulating layer 313) is pressed strongly. In an embodiment of the disclosure, an insulating layer within a CCL (e.g., the insulating layer 312) may have a thickness of 140 μm or less after hot pressing. On the other hand, the insulating layer between the CCLs (e.g., the insulating layer 313) may have a thickness of 120 μm or less after hot pressing.

In FIG. 12, although the plurality of heating coil pattern layers are shown as eight, this is only an embodiment of the disclosure, and according to an embodiment of the disclosure, the number of the plurality of heating coil pattern layers may be adjusted according to a design. For example, the number of the plurality of heating coil pattern layers may be four. Alternatively, in an embodiment of the disclosure, a heating coil board having a total of 16 heating coil pattern layers may be used in which eight CCLs, each including two heating coil pattern layers and an insulating layer therebetween, are laminated.

When a heating coil is patterned onto a PCB, as shown in FIG. 12, the manufacturing process may be simplified and the manufacturing costs may be reduced compared to when fabricating the heating coil by winding it with a litz wire. Furthermore, when the heating coil is patterned onto the PCB, the accuracy of inductance of the heating coil is higher than when the heating coil is fabricated by winding it with a litz wire, so a constant heating level may be obtained.

In addition, when the heating coil is patterned on the PCB, the amount of copper used for the same heating output is only one third of that when the heating coil is fabricated by winding it with litz wire, so the use of copper may be reduced.

When 1 ounce (oz) of copper is used in a PCB base plate (having a size of 1020 mm×1200 mm or 1020 mm×1020 mm) used to fabricate a heating coil pattern layer, insulation may be secured between the plurality of insulating layers 311, 312, 313, 314, 315, 316, 317, 318 and 319 and the plurality of heating coil pattern layers 11, 12, . . . , and 18 during hot pressing of the laminated board 300 on which the PCB base plate is laminated, but the amount of copper as a heating coil required for high power may be insufficient. When the amount of copper is insufficient, overheating may occur in a heating coil pattern, and heat loss may increase. In order to reduce the heat generated in the heating coil pattern, there is a method of increasing a width of the heating coil pattern, but increasing the width of the heating coil pattern poses a design difficulty because this makes it difficult to secure a large number of turns and therefore difficult to obtain an appropriate inductance. Therefore, a method for solving this problem is to increase a thickness of the heating coil pattern.

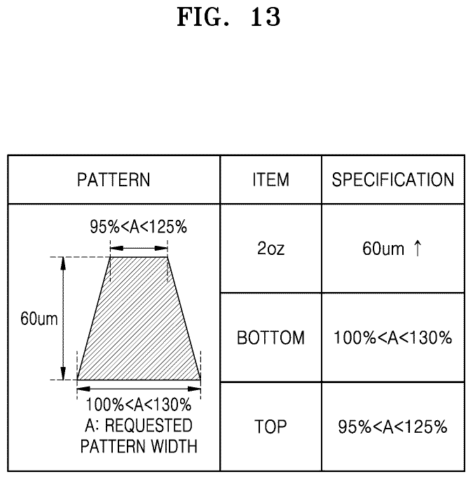

FIG. 13 illustrates a heating coil pattern width specification according to an embodiment of the disclosure.

Unlike a general copper pattern on a PCB, a heating coil pattern (or a patterned heating coil) needs to handle a large power capacity. Therefore, because a large amount of current has to flow through the patterned heating coil, the heating coil pattern needs to be wider or thicker (higher) than the general copper pattern.

To increase the thickness of the heating coil pattern, 2 oz of copper may be used in a PCB base plate instead of the existing 1 oz of copper.

FIG. 13 shows a cross-sectional view of a copper pattern when 2 oz of copper is used in the PCB base plate. As seen in FIG. 13, the copper pattern has a height of 35 μm when 1 oz of copper is used, whereas it has a height of 60 μm or more when 2 oz of copper is used. A requested width is a width requested by the customer who manufactures the induction heating apparatus 2000, and a top portion of a pattern may be between 95% and 125% of the requested width A while a bottom portion of the pattern may be between 100% and 130% of the requested width A. Normally, when copper in a liquid state is melted, the liquid copper forms a trapezoidal shape with slightly different widths at the top and bottom, as shown in FIG. 13.

However, when 2 oz or more of copper (e.g., 2 oz to 3 oz of copper) is used in the PCB base plate, the copper may become too thick, causing one prepreg insulation layer 312a to be pressed in a liquid state and come in contact with the copper when hot-pressing the laminated board 300 shown in FIG. 12.

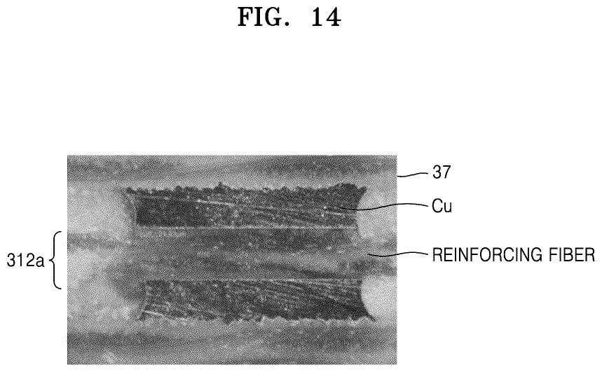

A partial cross-section 37 of a heating coil in FIG. 12 is shown in FIG. 14.

FIG. 14 illustrates a partial cross-section of a laminated board according to an embodiment of the disclosure.

As seen in the partial cross-section 37 of the heating coil, copper comes into contact with a reinforced fiber included in an insulating material in the middle due to hot pressing. Thus, to prevent the copper from coming into contact with the reinforced fiber as shown in FIG. 14, according to an embodiment of the disclosure, an insulating layer with at least two prepreg layers stacked is used. In an embodiment of the disclosure, the at least two prepreg layers may have a thickness of about 140 μm or less before hot pressing. In an embodiment of the disclosure, the at least two prepreg layers need to have a thickness of 130 μm or less or 140 μm or less before hot pressing, such that the heating coil board has a thickness of 3.3 mm or less after the hot pressing.

The one prepreg insulation layer 312a includes a resin component (or resin contents), and the resin component may flow out when a multi-layer PCB is formed and hot-pressed. The resin component that flows out comes into contact with the reinforced fiber included in the prepreg insulation layer 312a, resulting in poor adhesion in a portion of the prepreg insulation layer 312a. When pattern layers are not properly bonded to each other by the prepreg insulation layer 312a, a corresponding heating coil pattern may be lifted from the inside as current flows through the heating coil, and when the heating coil pattern is lifted, moisture or air enters the lifted heating coil pattern, causing the PCB to swell. To prevent this phenomenon, a method of laminating two prepreg insulation layers 312a and 312b between the heating coil pattern layers as an insulating layer, as shown in FIG. 12, may be used.

The insulating layer uses a prepreg insulation layer having a resin content of at least 60% (RC60) but not more than 80% (RC80), and includes two or more layers of the prepreg insulation layers 312a and 312b having such a resin content. One of the prepreg insulation layers 312a and 312b may have a thickness of 70 μm or less before hot pressing. Therefore, the two prepreg insulation layers 312a and 312b may have a thickness of 130 μm or less or 140 μm or less. The resin content of at least 60% (RC60) but not more than 80% (RC80) means that the resin accounts for 60% to 80% of the total composition of a compound included in the prepreg insulation layer.

Referring back to FIG. 12, each of the layers in the laminated board 300 is described.

According to an embodiment of the disclosure, each layer constituting the laminated board 300 may include a hole 25 through which a temperature sensor may pass. The temperature sensor may sense a temperature of the cooking vessel 101 that is placed on the top plate of the induction heating apparatus 2000.

According to an embodiment of the disclosure, an uppermost layer of the laminated board 300 may include the vessel sensing coil layer 33 that includes only a vessel sensing coil for detecting whether the cooking vessel 101 is placed on the top plate 5 of the induction heating apparatus 2000. However, this is only an embodiment of the disclosure, and the vessel sensing coil may be patterned together with the heat coil and included in the first heating coil pattern layer 11 which is the uppermost heating coil pattern layer among the plurality of heating coil pattern layers 11, 12, . . . , and 18. When the vessel sensing coil is patterned together on the heating coil pattern layer, inductive power may be applied to the container sensing coil by the heating coil. Therefore, according to an embodiment of the disclosure, the laminated board 300 may be designed such that the vessel sensing coil is included in the vessel sensing coil layer 33 separate from the heating coil pattern layers. According to an embodiment of the disclosure, the vessel sensing coil layer 33 may have a thickness of 110 μm or less after hot pressing.

The insulating layer 311 including two prepreg insulation layers may be located between the vessel sensing coil layer 33 and the first heating coil pattern layer 11 for insulation and adhesion. The insulating layer 311 between the vessel sensing coil layer 33 and the first heating coil pattern layer 11 may be thinner than the insulating layer 312 including the two prepreg insulation layers 312a and 312b and located between the first heating coil pattern layer 11 and the second heating coil pattern layer 12. In an embodiment of the disclosure, the insulating layer 311 between the vessel sensing coil layer 33 and the first heating coil pattern layer 11 may have a thickness of 130 μm or less. In addition, the amount (0.5 oz to 1 oz) of copper used in the PCB base plate to fabricate the vessel sensing coil layer 33 may be less than the amount (2 oz to 3 oz) of copper used in a heating coil pattern layer. The reason is that the vessel sensing coil in the vessel sensing coil layer 33 is used for sensing the cooking vessel 101, so the amount of copper used therefor may be less than that for the heating coil for high power.

According to an embodiment of the disclosure, the vessel sensing coil layer 33 may include a temperature detector for detecting a temperature of the heating coil board 10 when the induction heating apparatus 2000 heats the cooking vessel 101.

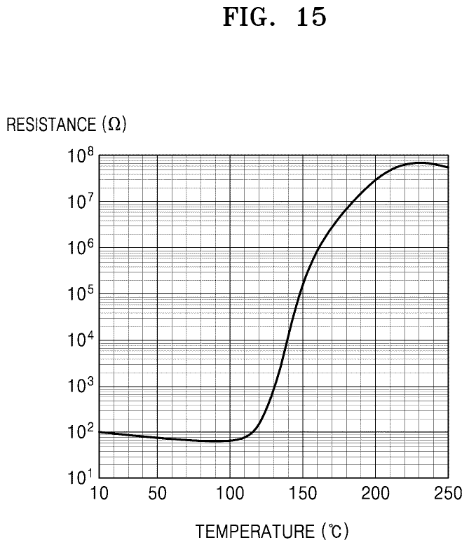

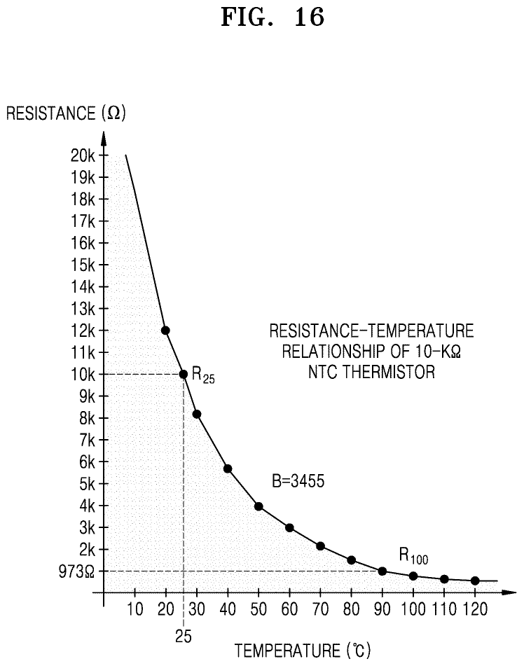

FIGS. 15 and 16 are characteristic curves of a temperature detector according to an embodiment of the disclosure.

The temperature detector may include a positive temperature coefficient (PTC) thermistor or a negative temperature coefficient (NTC) thermistor. FIG. 15 is a characteristic curve of a PTC thermistor according to an embodiment of the disclosure.

As seen in FIG. 15, the PTC thermistor has a characteristic that its resistance increases as a temperature at a location where the PTC thermistor is attached increases. For example, the PTC thermistor has a resistance of 1 kiloohm (kΩ) when a detected temperature is around 130° C. The PTC thermistor also has a resistance of 100Ω or less when a detected temperature is around 100° C. However, the PTC thermistor according to FIG. 15 is only an example, and PTC thermistors may also have different temperature-resistance characteristic curves depending on a type.

FIG. 16 is a characteristic curve of an NTC thermistor according to an embodiment of the disclosure.

As seen on FIG. 16, the NTC thermistor has a characteristic that its resistance decreases as a temperature at a location where the NTC thermistor is attached increases. For example, the NTC thermistor has a resistance of 973Ω at a detected temperature of around 100° C. The NTC thermistor also has a resistance of 10 kΩ at a detected temperature of around 25° C. However, the NTC thermistor according to FIG. 16 is only an example, and NTC thermistors may also have different temperature-resistance characteristic curves depending on a type.

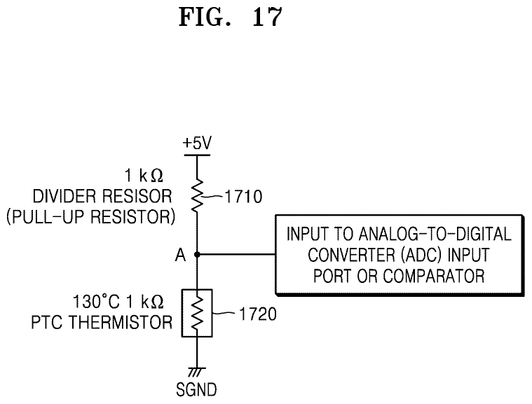

FIG. 17 illustrates a temperature detection circuit according to an embodiment of the disclosure.

FIG. 17 illustrates a temperature detection circuit using a thermistor as a temperature detector, according to an embodiment of the disclosure.

The temperature detection circuit of FIG. 17 may include a divider resistor 1710 and a PTC thermistor 1720 as a temperature detector, and a voltage detected at point A that is an output of the temperature detection circuit may be input to an analog-to-digital converter (ADC) input port. However, this is only an embodiment of the disclosure, and a voltage detected at the point A that is the output of the temperature detection circuit may be directly input to a processor (not shown) having, for example, an ADC input port, or may be input to a comparator and compared to a predetermined value. The PTC thermistor 1720 detects a temperature of the heating coil board 10.

Referring to FIG. 17, an input voltage of +5 volts (V) is distributed by the divider resistor 1710 of 1 kΩ and the PTC thermistor 1720. The divider resistor 1710 is a resistor that distributes the input voltage of +5 V with the PTC thermistor 1720. Also, it can be seen in FIG. 17 that the divider resistor 1710 is a pull-up resistor. The point A between the divider resistor 1710 and the PTC thermistor 1720 is connected to the ADC input port or a comparator input. The divider resistor 1710 is shown as one in FIG. 17, but a plurality of divider resistors may be used. In FIG. 17, the PTC thermistor 1720 is shown to have a resistance of 1 kΩ at 130° C., but the resistance at a specific temperature may vary depending on a type of PTC thermistor 1720. Referring to FIG. 17, a voltage across the point A at 130° C. is 2.5 V. It is assumed herein that a temperature at which the heating coil board 10 is determined to be overheated is 130° C. When the resistance of the PTC thermistor 1720 is 1 kΩ at 130° C., a voltage across the point A is 2.5 V. Therefore, the processor that detects a digital value corresponding to 2.5 V may determine that the heating coil board 10 is overheated. When determining that the heating coil board 10 is overheated, the processor may subsequently perform an overheating prevention operation. The temperature at which the heating coil board 10 is determined to be overheated may be arbitrarily selected by a designer according to specifications of materials forming the heating coil board 10. In this way, the point A, which reads a voltage value that varies due to a change in resistance of the PTC thermistor 1720 as the temperature changes, may be referred to as the output of the temperature detection circuit.

According to an embodiment of the disclosure, when a temperature detected by the temperature detector included in the heating coil board 10 is higher than or equal to a predetermined temperature, e.g., when a temperature detected in a heating coil pattern layer is 130° C. or higher, the induction heating apparatus 2000 may lower a power output of the induction heating apparatus 2000. It is assumed herein that the power output of the induction heating apparatus 2000 is divided into levels 1 to 10, and the induction heating apparatus 2000 is currently performing a heating operation at level 10. For example, when the temperature of the heating coil pattern layer is detected by the temperature detector to be 130° C., the induction heating apparatus 2000 may automatically lower the output power to level 9. When the induction heating apparatus 2000 lowers the output power to level 9, but the temperature of the heating coil pattern layer does not drop below 130° C. within a predetermined time period, e.g., 30 seconds, the induction heating apparatus 2000 may automatically lower the output power further to level 8.

On the other hand, when the temperature of the heating coil pattern layer drops below a predetermined second temperature, e.g., 90° C., while the output power is at level 8, the induction heating apparatus 200 may raise the output power back to level 9. In this way, the power output of the induction heating apparatus 2000 may be adjusted according to the temperature of the heating coil pattern layer via the temperature detector. In an embodiment of the disclosure, adjustment of the power output of the induction heating apparatus 2000 may be performed by the processor of the induction heating apparatus 2000.

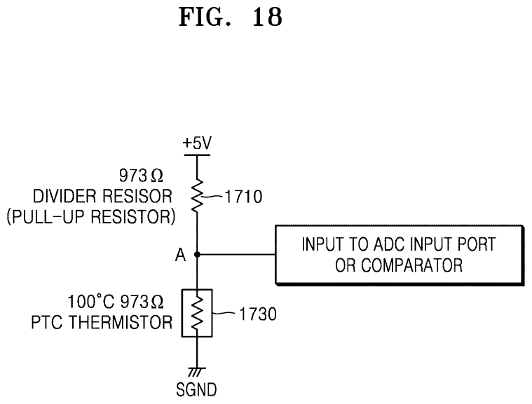

FIG. 18 illustrates a temperature detection circuit according to an embodiment of the disclosure.

The temperature detection circuit of FIG. 18 may include a divider resistor 1710 and an NTC thermistor 1730 as a temperature detector, and a voltage detected at point B that is an output of the temperature detection circuit may be input to an ADC input port or comparator.

The NTC thermistor 1730 detects a temperature of the heating coil board 10. The divider resistor 1710 is a resistor that distributes an input voltage of +5 V with the NTC thermistor 1730.

Referring to FIG. 18, the input voltage of +5 V is distributed by the divider resistor 1710 of 973Ω and the NTC thermistor 1730. In FIG. 18, the divider resistor 1710 is a pull-up resistor. The point B between the divider resistor 1710 and the NTC thermistor 1730 is connected to the ADC input port or to an ADC input port or a comparator input of a processor (not shown) when the processor has the ADC input port. The divider resistor 1710 is shown as one in FIG. 18, but a plurality of divider resistors may be used. In FIG. 18, the NTC thermistor 1730 is shown to have a resistance of 973Ω at 100° C., but a resistance corresponding to temperature may vary depending on a type of NTC thermistor 1730. It is assumed herein that a temperature at which the heating coil board 10 is determined to be overheated is 100° C. Referring to FIG. 18, when the resistance of the NTC thermistor 1730 is 973Ω at 100° C., a voltage across the point B is 2.5 V. Therefore, the processor that detects a digital value corresponding to 2.5 V may determine that the heating coil board 10 is overheated. When determining that the heating coil board 10 is overheated, the processor may selectively perform an overheating prevention operation. The temperature at which the heating coil board 10 is determined to be overheated may be arbitrarily selected by a designer according to specifications of the heating coil board 10. In this way, the point B, which reads a voltage value that varies according to resistance of the PTC thermistor 1720 may be referred to as the output of the temperature detection circuit.

According to an embodiment of the disclosure, when a temperature detected by the temperature detector included in the vessel coil sensing layer 33 is higher than or equal to a predetermined temperature, e.g., when a temperature detected in a heating coil pattern layer is 100° C. or higher, the induction heating apparatus 2000 may lower a power output of the induction heating apparatus 2000. It is assumed herein that the power output of the induction heating apparatus 2000 is divided into levels 1 to 10, and the induction heating apparatus 2000 is currently performing a heating operation at level 8. For example, when the temperature of the heating coil pattern layer is detected by the temperature detector to be 100° C., the induction heating apparatus 2000 may automatically lower the output power to level 7. When the induction heating apparatus 2000 lowers the output power to level 7, but the temperature of the heating coil pattern layer does not drop below 100° C. within a predetermined time period, the induction heating apparatus 2000 may automatically lower the output power further to level 6.

On the other hand, when the temperature of the heating coil pattern layer drops below a predetermined second temperature, e.g., 80° C., while the output power is at level 7, the induction heating apparatus 200 may raise the output power back to level 8. In this way, the power output of the induction heating apparatus 2000 may be adjusted according to the temperature of the heating coil pattern layer via the temperature detector. In an embodiment of the disclosure, adjustment of the power output of the induction heating apparatus 2000 may be performed by the processor of the induction heating apparatus 2000.

Referring back to FIG. 12, according to an embodiment of the disclosure, a lowermost layer of the laminated board 300 may include the signal layer 35 for connector connection, on which a connector is mounted for making a connector connection between the heating coil board 10 and the inverter board 30 of the induction heating apparatus 2000. According to an embodiment of the disclosure, the signal layer 35 for connector connection may have a thickness of 110 μm or less after hot pressing. The insulating layer 319 with two prepreg insulation layers stacked may be disposed between the signal layer 35 for connector connection and the eighth heating coil pattern layer 18 for insulation and adhesion. The insulating layer 319 with the two prepreg insulation layers stacked, which is between the signal layer 35 and the eighth heating coil pattern layer 18, may be thinner than the insulating layer 318 with two prepreg insulation layers stacked, which is between the seventh heating coil pattern layer 17 and the eighth heating coil pattern layer 18. In an embodiment of the disclosure, when a thickness of the insulation layer 319 between the signal layer 35 for connector connection and the eighth heating coil pattern layer 18 is 120 μm or less, a thickness of the insulation layer 318 between the seventh heating coil pattern layer 17 and the eighth heating coil pattern layer 18 may be 130 μm or less, which is slightly greater than that. In addition, the amount (0.5 oz to 1 oz) of copper used in the PCB base plate to fabricate the signal layer 35 for connector connection may be less than the amount (2 oz to 3 oz) of copper used in a heating coil pattern layer. The reason is that a signal coil in the signal layer 35 for connector connection is used for signal transmission, so the amount of copper used therefor may be less than that for the heating coil for high power.

The mounting of a connector for connection between boards such as the heating coil board 10 and the inverter board 30 is described with reference to FIGS. 19 to 21.

FIG. 19 illustrates a structure in which boards of an induction heating apparatus are connected to each other, according to an embodiment of the disclosure.

Referring to FIG. 19, according to an embodiment of the disclosure, the induction heating apparatus 2000 may include the top plate 5 on which the cooking vessel 101 is placed, and the heating coil board 10 positioned below the top plate 5 and having a plurality of heating coils patterned and laminated thereon. According to an embodiment of the disclosure, the induction heating apparatus 2000 may include an intermediate board 20 positioned below the heating coil board 10 and including a relay, a resonant capacitor, etc. In an embodiment of the disclosure, the intermediate board 20 may include a memory storing a program for controlling operations of the induction heating apparatus 2000 and a processor for executing the program stored in the memory to control the induction heating apparatus 2000.

According to an embodiment of the disclosure, the induction heating apparatus 2000 may include the inverter board 30 positioned below the intermediate board 20 and including an inverter and a power converter. According to an embodiment of the disclosure, a resonant capacitor may be included in the inverter board 30. In an embodiment of the disclosure, the intermediate board 20 and the inverter board 30 may be combined into a single inverter board according to design specifications. The inverter board 30 may include a plurality of electronic switches constituting the inverter. The plurality of electronic switches perform pulse width modulation (PWM) switching. The PWM switching may cause resonance between a heating coil 2120 included in the heating coil board 10 and a resonant capacitor, thereby inducing an eddy current in the cooking vessel 101. The inverter board 30 may include the power converter for generating a low DC voltage used for the processor, memory, etc. included in the intermediate board 20. The power converter may also generate a voltage of +15 V or +12 V for switching of the plurality of electronic switches of the inverter. In the disclosure, the power converter may be referred to as a switched-mode power supply (SMPS).

In an embodiment of the disclosure, the intermediate board 20 may be electrically connected to the inverter board 30 by a first connector 110 mounted vertically on a lower surface of the intermediate board 20 being accommodated by a second connector 120 mounted vertically on an upper surface of the inverter board 30. In this case, in an embodiment of the disclosure, the electrical connection between the intermediate board 20 and the inverter board 30 may be made only by a connection between the first connector 110 and the second connector 120.

In an embodiment of the disclosure, the first connector 110 mounted vertically on the lower surface of the intermediate board 20 may be a male connector, and the second connector 120 mounted vertically on the upper surface of the inverter board 30 may be a female connector. In an embodiment of the disclosure, conversely, the first connector 110 mounted vertically on the lower surface of the intermediate board 20 may be a female connector, and the second connector 120 mounted vertically on the upper surface of the inverter board 30 may be a male connector.

When the heating coil board 10, the intermediate board 20, and the inverter board 30 are connected via connectors as shown in FIG. 19, wires are no longer required to connect between the boards, and thus, product defects due to the wires are prevented. Furthermore, the connection via connectors eliminates inconvenience in assembly or an increase in manufacturing costs due to the wires. Therefore, a structure in which boards are connected using connectors, as shown in FIG. 19, may simplify product assembly and minimize product defects. This structure is possible because the heating coils are patterned so that the heating coil board 10 may be connected to the inverter board 30 only by connectors, as shown in FIG. 19.

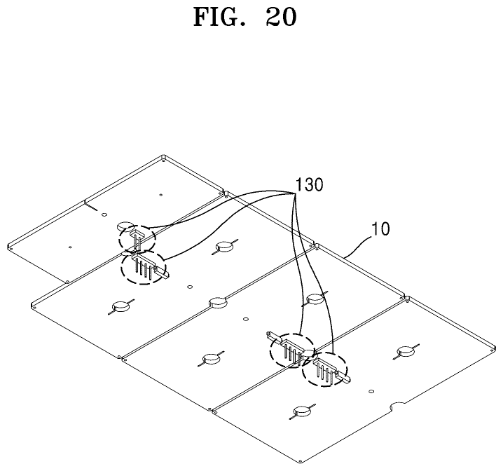

FIG. 20 illustrates a structure in which a connector is connected to a heating coil board in an induction heating apparatus, according to an embodiment of the disclosure.

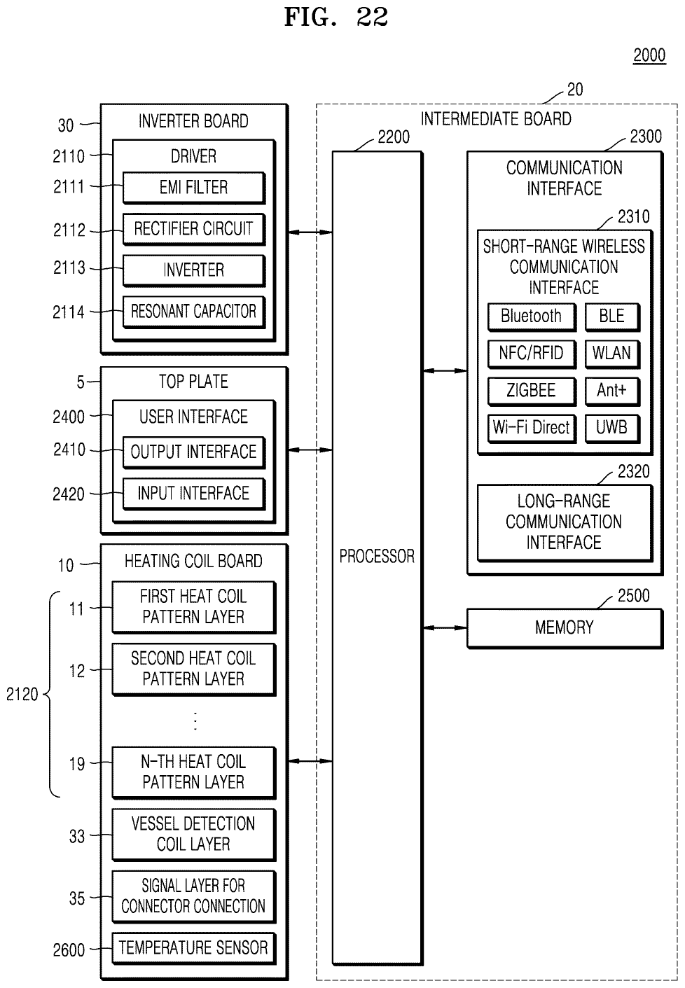

FIG. 20 shows a lower surface of the heating coil board 10 on which a heating coil board connector 130 is mounted, not an upper surface on which the top plate 5 is placed. The heating coil board connector 130 is mounted vertically on the lower surface of the heating coil board 10 for each heating coil 2120 to be electrically connected to the inverter (2113 of FIG. 22). The heating coil board connector 130 may be a male connector or a female connector. In the disclosure, the heating coil board connector 130 may be referred to as a third connector to distinguish it from the first connector 110 and the second connector 120 illustrated in FIG. 19. In an embodiment of the disclosure, the heating coil board connector 130 may have a structure in which it passes through a hole in the intermediate board 20 and is directly connected to a second connector 120 mounted vertically on the inverter board 30. Alternatively, in an embodiment of the disclosure, the heating coil board connector 130 may be connected to a fourth connector mounted on the intermediate board 20. In an embodiment of the disclosure, when the heating coil board connector 130 is connected to the fourth connector of the intermediate board 20, the intermediate board 20 has a resonant capacitor (2114 of FIG. 22) mounted thereon.

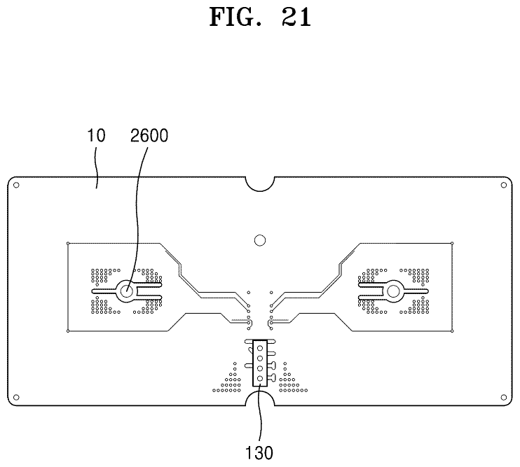

FIG. 21 illustrates a structure in which a connector is mounted on a back surface of a heating coil board in an induction heating apparatus, according to an embodiment of the disclosure.

FIG. 21 shows the lower surface of the heating coil board 10 similar to FIG. 20. The heating coil board 10 of FIG. 21 has a hole penetrating the entire heating coil board 10 in the center where the heating coil 2120 is printed and patterned, and a temperature sensor 2600 is installed in the hole. The temperature sensor 2600 may be used to measure the temperature of the cooking vessel 101 that is placed on the top plate 5 of the induction heating apparatus 2000.

The heating coil board 10 has a heating coil board connector 130 mounted vertically on the heating coil board 10 to be electrically connected to the intermediate board 20 and/or the inverter board 30 underlying the heating coil board 10.

This method of connecting between boards via connectors eliminates complex wire connections, thereby increasing the convenience of assembly and reducing the likelihood of product defects, as well as reducing manufacturing costs.

FIG. 22 is a block diagram of an induction heating apparatus according to an embodiment of the disclosure.

As shown in FIG. 22, according to an embodiment of the disclosure, the induction heating apparatus 2000 may include the top plate 5, the heating coil board 10, the intermediate board 20, and the inverter board 30.

According to an embodiment of the disclosure, the top plate 5 is a plate on which the cooking vessel 101 is placed, and is usually made of heat-resistant tempered glass. The top plate 5 may include an output interface 2410, such as the display 2411, and an input interface 2420, such as a touch button. In an embodiment of the disclosure, actual operations of the output interface 2410, such as a display. and the input interface 2420, such as a touch button, may be performed according to control by a processor 2200 included in the intermediate board 20 as described below. Also, in an embodiment of the disclosure, a display panel or actual touch button itself may be mounted on the intermediate board 20, and only a user interface 2400 may be mounted on the top plate 5.

The user interface 2400 to be included in the top plate 5 may include the output interface 2410 and the input interface 2420. The output interface 2410 is for outputting an audio signal or a video signal, and may include a display, an audio output interface, etc.

When the display and a touch pad form a layer structure to construct a touch screen, the display may serve as the input interface 2420 as well as the output interface 2410. The display may include at least one of a liquid crystal display (LCD), a thin-film transistor LCD (TFT-LCD), a light-emitting diode (LED) display, an organic LED (OLED) display, a flexible display, a three-dimensional (3D) display, or an electrophoretic display. Also, depending on the design, the induction heating apparatus 2000 may include two or more displays.

The audio output interface may output audio data received via a communication interface 2300 or stored in a memory 2500. The audio output interface may also output sound signals related to functions performed by the induction heating apparatus 2000. The audio output interface may include a speaker, a buzzer, and the like.

According to an embodiment of the disclosure, the output interface 2410 may display information about the cooking vessel 101. For example, the output interface 2410 may output a graphical user interface (GUI) corresponding to identification information or product type information of the cooking vessel 101. In addition, the output interface 2410 may output information regarding a current location of the cooking vessel 101 or a material of the cooking vessel 101.

The input interface 2420 is for receiving an input from the user. The input interface 2420 may be at least one of a keypad, a dome switch, a touch pad (a capacitive overlay type, a resistive overlay type, an infrared beam type, a surface acoustic wave type, an integral strain gauge type, a piezoelectric type, etc.), a jog wheel, or a jog switch, but is not limited thereto.

The input interface 2420 may include a speech recognition module. For example, the induction heating apparatus 2000 may receive a speech signal, which is an analog signal, via a microphone, and convert a part of speech into a computer-readable text by using an automatic speech recognition (ASR) model. The induction heating apparatus 2000 may obtain an intent in a user's utterance by interpreting the text using a natural language understanding (NLU) model. Here, the ASR model or NLU model may be an Al model. An Al model may be processed by a dedicated Al processor designed with a hardware structure specialized for processing an Al model. The Al model may be created via a training process. In this case, the creation via the training process means that predefined operation rules or Al model set to perform desired characteristics (or purpose) are created by training a base Al model based on a large number of training data via a learning algorithm. An Al model may consist of a plurality of neural network layers. Each of the plurality of neural network layers has a plurality of weight values and may perform neural network computations via calculations between a result of computations in a previous layer and the plurality of weight values.

Linguistic understanding is a technology for recognizing and applying/processing human language/characters and may include natural language processing, machine translation, a dialog system, question answering, speech recognition/synthesis, etc.

According to an embodiment of the disclosure, in the induction heating apparatus 2000, the heating coil board 10 may include the heating coil 2120 that is patterned and printed on a first heating coil pattern layer 11. The heating coil board 10 may have a structure in which a plurality of heating coil pattern layers are stacked together. The heating coil 2120 may be a plurality of heating coils, and the plurality of heating coil pattern layers may include the first heating coil pattern layer 11, a second heating coil pattern layer 12, 13, 14, 15, 16, 17, 18 and an nth heating coil pattern layer 19 (where n is a natural number greater than or equal to 2, and n=4, 8, 12, and 16). The heating coil board 10 may include a signal layer 35 for connector connection on which a connector may be vertically mounted for connection with the intermediate board 20 and/or the inverter board 30 by using the connector instead of wires.

The heating coil 2120 patterned on the heating coil board 10 may generate a magnetic field for heating the cooking vessel 101. For example, when a current is supplied to the heating coil 2120, a magnetic field may be induced around the heating coil 2120. When a current whose magnitude and direction change with time, i.e., an AC current, is supplied to the heating coil 2120, a magnetic field whose magnitude and direction vary with time may be induced around the heating coil 2120. The magnetic field around the heating coil 2120 may pass through the top plate 5 made of tempered glass and reach the cooking vessel 101 placed on the top plate 5. Due to the magnetic field whose magnitude and direction change over time, an eddy current circulating around the magnetic field may occur in the cooking vessel 101, and the eddy current may generate resistive heat in the cooking vessel 101. The resistive heat is the heat generated in a resistor when current flows through the resistor, and is also referred to as Joule heat. The cooking vessel 101 and the contents in the cooking vessel 101 may be heated by the electrical resistive heat.

According to an embodiment of the disclosure, in the induction heating apparatus 2000, the heating coil board 10 may further include a temperature sensor 2600. The temperature sensor 2600 may sense a temperature of the top plate 5 or the cooking vessel 101 placed on the top plate 5. Based on the temperature of the cooking vessel 101 sensed by the temperature sensor 2600, the processor 2200 may determine whether the cooking vessel 101 is undergoing empty heating or is overheating. In an embodiment of the disclosure, the temperature sensor 2600 may be installed in a hole penetrating the heating coil board 10.

According to an embodiment of the disclosure, the heating coil board 10 of the induction heating apparatus 2000 may further include a vessel sensing coil layer 33. In an embodiment of the disclosure, the vessel sensing coil layer 33 may include a vessel sensing coil. In an embodiment of the disclosure, the vessel sensing coil may be printed in the form of a pattern on the first heating coil pattern layer 11. The processor 2200 of the induction heating apparatus 2000 may detect whether the cooking vessel 101 is placed on the top plate 5 of the induction heating apparatus 2000 via the vessel sensing coil included in the vessel sensing coil layer 33 or the first heating coil pattern layer 11.

The inverter board 30 may include a driver 2110. The driver 2110 may receive power from an input power source and supply a current to the heating coil 2120 according to a driving control signal from the processor 2200. The driver 2110 may include an EMI filter 2111, a rectifier circuit 2112, an inverter 2113, and a resonant capacitor 2114, but is not limited thereto. In an embodiment of the disclosure, the resonant capacitor 2114 may be located on the intermediate board 20 rather than the inverter board 30, depending on design specifications.

The EMI filter 2111 may block high-frequency noise included in an AC voltage supplied from the input power source while allowing an AC voltage and an AC current of a predetermined frequency (e.g., 50 Hz or 60 Hz) to pass through. A fuse and a relay may be provided between the EMI filter 2111 and the input power source to block overcurrent. The AC voltage from which the high-frequency noise is blocked by the EMI filter 2111 is supplied to the rectifier circuit 2112.

The rectifier circuit 2112 may convert the AC voltage into a DC voltage. For example, the rectifier circuit 2112 may convert an AC voltage whose magnitude and polarity (positive or negative voltage) change over time into a DC voltage whose magnitude and polarity remain constant over time, and convert an AC current whose magnitude and direction (positive or negative current) change over time into a DC current whose polarity does not change over time. The rectifier circuit 2112 may include a diode as an element for rectification. For example, the rectifier circuit 2112 may include four diodes. A diode may convert an AC voltage whose polarity changes over time into a positive voltage having a constant polarity, and convert an AC current whose direction changes over time into a positive current that flows in a constant direction. The rectifier circuit 2112 may be connected to a DC link capacitor that smooths the rectified DC voltage.

The inverter 2113 may include a switching circuit for supplying or blocking a driving current to the heating coil 2120. The inverter 2113 may generate resonance between the heating coil 2120 and the resonant capacitor 2114 through a switching operation of the switching circuit. In an embodiment of the disclosure, the resonant capacitor 2114 may be included in the inverter board 30 or may be included in the intermediate board 20. The switching circuit may include two switches for each heating zone, as illustrated in FIG. 3. The first switch 2113_1 and the second switch 2113_2 illustrated in FIG. 3 may be turned on or off according to a driving control signal from the processor 2200. In an embodiment of the disclosure, the induction heating apparatus 2000 may include a separate driving processor in addition to the processor 2200 to generate a driving control signal.

The inverter 2113 may control a current supplied to the heating coil 2120. For example, a magnitude and a direction of the current flowing through the first heating coil 2120_1 may change according to turning on/off of the first switch 2113_1 and the second switch 2113_2 included in the inverter 2113. In addition, a magnitude and a direction of the current flowing through the second heating coil 2120_2 may change according to the turning on/off of another switch pair included in the inverter 2113. In this case, an AC current may be supplied to the first heating coil 2120_1 and the second heating coil 2120_2.

The inverter board 30 may include a connector (not shown) through which a board-to-board connection may be made with the intermediate board 20.

According to an embodiment of the disclosure, in the induction heating apparatus 2000, the intermediate board 20 may be positioned between the heating coil board 10 and the inverter board 30. The intermediate board 20 may be a first board when the inverter board 30 is a second board. According to an embodiment of the disclosure, the intermediate board 20 may include, but is not limited to, the processor 2200, the communication interface 2300, and the memory 2500. For example, the intermediate board 20 may further include the resonant capacitor 2114. In addition, components included in the intermediate board 20 may be electrically connected to components included in the inverter board 30 via the connector of the inverter board 30.

According to an embodiment of the disclosure, the intermediate board 20 may include the resonant capacitor 2114. However, this is only an embodiment of the disclosure, and the resonant capacitor 2114 may be included in the inverter board 30 according to design specifications. The resonant capacitor 2114 may induce an eddy current in the cooking vessel 101 placed on the top plate 5 of the induction heating apparatus 2000 by resonating with the heating coil 2120 driven by the switching of the inverter 2113. As shown in FIG. 3, when there are a plurality of heating coils 2120, the resonant capacitor 2114 may be provided as a plurality of resonant capacitors to correspond to the heating coils 2120.

The processor 2200 of the intermediate board 20 may determine a switching frequency (turn-on/turn-off frequency) of the switching circuit included in the inverter t 2113, based on an output power (power level) of the induction heating apparatus 2000. The processor 2200 may generate a driving control signal for turning on/off the switching circuit according to the determined switching frequency. The induction heating apparatus 2000 may include a driving processor separate from the processor 2200 to control operation of the driver 2110 including the inverter 2113 during operation of the processor 2200. However, this is only an embodiment of the disclosure, and the operation of the driving processor may be performed by the processor 2200.

The processor 2200 controls all operations of the induction heating apparatus 2000.

The processor 2200 is a hardware device that controls all operations of the induction heating apparatus 2000. The processor 2200 may include one processor or a plurality of processors. According to an embodiment of the disclosure the processor 2200 may be a hardware processing circuit including at least one of a central processing unit (CPU), a graphics processing unit (GPU), an accelerated processing unit (APU), a Many Integrated Core (MIC), a digital signal processor (DSP), an integrated circuit (IC), or a neural processing unit (NPU). The processor 2200 may be implemented in the form of an integrated system on a chip (SoC) including one or more electronic components. When the processor 2200 includes a plurality of processors, each processor may be implemented as a separate piece of hardware (H/W). The processor 2200 may also be referred to as a microprocessor controller (MICOM), a microprocessor unit (MPU), or a microcontroller unit (MCU). According to an embodiment of the disclosure, the processor 2200 is a hardware device that may be implemented as a single-core processor or as a multi-core processor. The processor 2200 may control the driver 2110, the communication interface 2300, the user interface 2400, and the memory 2500 by executing programs stored in the memory 2500.

According to an embodiment of the disclosure, the induction heating apparatus 2000 may be equipped with an artificial intelligence (AI) processor. The AI processor may be manufactured in the form of a dedicated hardware chip for AI, or manufactured as part of an existing general-purpose processor (e.g., a CPU or an application processor (AP)) or a dedicated graphics processor (e.g., a GPU) and mounted on the induction heating apparatus 2000.

The processor 2200 may establish a short-range wireless communication channel (e.g., a BLE communication channel) with the cooking vessel 101 via the communication interface 2300 when the unique identification information of the cooking vessel 101 is stored in the memory 2500.

The processor 2200 may perform asymmetrical control between the plurality of heating coils 2120. In an embodiment of the disclosure, when an operating frequency of the first heating coil 2120_1 of FIG. 3 is f₁ and an operating frequency of the second heating coil 2120_2 is f₂ (f₁<f₂), the processor 2200 may control the operating frequency f₂ of the second heating coil 2120_2 to be equal to the operating frequency f₁. At the same time, the processor 2200 may perform asymmetrical control to set turn-on/turn-off duty ratios of the third switch 2113_3 and the fourth switch 2113_4 differently when the operating frequency of the second heating coil 2120_1 is f₁ so that an output from a heating zone corresponding to the second heating coil 2120_2 when the operating frequency of the second heating coil 2120_2 is f₂ is the same as an output when the operating frequency of the second heating coil 2120_2 is f₁.

The communication interface 2300 of the intermediate board 20 may include one or more components that enable communication between the induction heating apparatus 2000 and the cooking vessel 101, the induction heating apparatus 2000 and a server (not shown), or the induction heating apparatus 2000 and a user terminal (not shown). For example, the communication interface 2300 may include a short-range communication interface 2310 and a long-range communication interface 2320. The short-range communication interface 2310 may include, but is not limited to, a Bluetooth communication interface, a BLE communication interface, an NFC interface, a WLAN (or Wi-Fi) communication interface, a ZigBee communication interface, an IrDA communication interface, a WFD communication interface, a UWB communication interface, an Ant+ communication interface, etc. The long-range communication interface 2320 may be used to communicate with a server (not shown) when the cooking vessel 101 is remotely controlled by the server in an IoT environment. The long-range communication interface 2320 may include the Internet, a computer network (e.g., a LAN or a WAN), and a mobile communication interface. The mobile communicator transmits or receives a wireless signal to or from at least one of a base station, an external terminal, or a server on a mobile communication network. In this case, the wireless signal may be a voice call signal, a video call signal, or data in any one of various formats according to transmission and reception of a text/multimedia message. The mobile communication interface may include, but is not limited to, a 3G module, a 4G module, an LTE module, a 5G module, a 6G module, an NB-IoT module, an LTE-M module, etc.

The memory 2500 may store programs for operating and controlling the induction heating apparatus 2000 by the processor 2200, and may store input/output data (e.g., unique identification information of the cooking vessel 101, variable identification information of the cooking vessel 101, a plurality of power transmission patterns, cooking progress information of the cooking vessel 101, material information of the cooking vessel 101, etc.). The memory 2500 may store a coded command regarding a switching operation for driving the inverter 2113. The memory 2500 may also store an Al model.

The memory 2500 may include at least one type of storage medium, i.e., at least one of a flash memory-type memory, a hard disk-type memory, a multimedia card micro-type memory, a card-type memory (e.g., a Secure Digital (SD) card or an extreme Digital (XD) memory), random access memory (RAM), static RAM (SRAM), read-only memory (ROM), electrically erasable programmable ROM (EEPROM), PROM, a magnetic memory, a magnetic disc, or an optical disc. In addition, the induction heating apparatus 2000 may operate a web storage or cloud server that performs storage functions on the Internet.

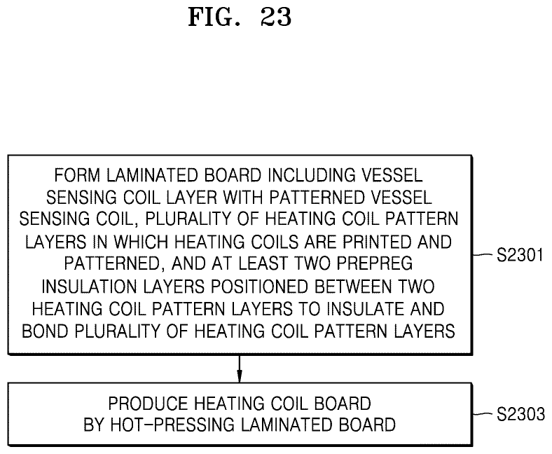

FIG. 23 is a flowchart of a method of producing a heating coil board according to an embodiment of the disclosure.

In operation S2301, a laminated board is formed, which includes a vessel sensing coil layer with a patterned vessel sensing coil, a plurality of heating coil pattern layers in which heating coils are printed and patterned, and at least two prepreg insulation layers positioned between the two adjacent heating coil pattern layers to insulate and bond the plurality of heating coil pattern layers.

The vessel sensing coil layer may be located at a top of the laminated board, and an insulating layer may also be inserted between the vessel sensing coil layer and an uppermost layer of the plurality of heating coil pattern layers. The insulating layer may include two prepreg insulation layers. Each of the prepreg insulation layers may have a thickness of 70 μm or less before hot pressing. In addition, a signal layer for connector connection may be included in a lowermost layer of the laminated board. An insulating layer formed by stacking two prepreg insulation layers having a thickness of 70 μm or less before hot pressing may be inserted between the signal layer for connector connection and a lowermost layer among the plurality of heating coil pattern layers. In addition, a thickness of the signal layer for connector connection may be 110 μm or less when the laminated board is hot-pressed.

In this case, a PCB base plate for forming the laminated board may have a size of 1020 (mm)×1200 (mm) or 1020 (mm)×1020 (mm), and 2 oz or more of copper is used in the PCB base plate used to fabricate a heating coil board. 0.5 oz to 1 oz of copper may be used in a PCB base plate used for the vessel sensing coil layer and the signal layer for connector connection.

Each of the prepreg insulation layers contains a resin content of 60% to 80%.

Each layer in the laminated board may include a hole through which a temperature sensor for sensing the temperature of the cooking vessel 101 may pass.

In operation S2303, a heating coil board is produced by hot-pressing the laminated board. Even when the laminated board is hot-pressed, because an insulating layer includes at least two prepreg insulation layers, conductors of the plurality of heating coil pattern layers do not contact reinforced fibers of the prepreg insulation layers, thereby maintaining insulation between the plurality of heating coil pattern layers. A thickness of the heating coil board produced by hot pressing may be 3.3 mm or less.

There is provided an induction heating apparatus including a plurality of heating coil pattern layers in which heating coils are printed and patterned, according to an embodiment of the disclosure. According to an embodiment of the disclosure, the induction heating apparatus may include a vessel sensing coil for detecting a cooking vessel. According to an embodiment of the disclosure, the induction heating apparatus may include a heating coil board including heating coils for heating the cooking vessel. According to an embodiment of the disclosure, the heating coil board may be produced by hot-pressing the plurality of heating coil pattern layers in which the heating coils are printed and patterned and a plurality of insulating layers for insulation between the plurality of heating coil pattern layers. According to an embodiment of the disclosure, each of the plurality of insulating layers may include at least two prepreg insulation layers.

According to an embodiment of the disclosure, each of the plurality of insulating layers may include a resin content of 60% to 80% of the total composition thereof.

According to an embodiment of the disclosure, a height of a conductor of each of the plurality of heating coil pattern layers included in the heating coil board may be 60 μm or more, and each of the plurality of insulating layers may have a thickness of 140 μm or less before hot pressing.

According to an embodiment of the disclosure, the heating coil board may include a hole through which a temperature sensor for detecting a temperature of the cooking vessel passes.

According to an embodiment of the disclosure, the heating coil board may include a vessel sensing coil layer including only a vessel sensing coil as an uppermost layer.

According to an embodiment of the disclosure, the heating coil board may further include an insulating layer positioned between the vessel sensing coil layer and a heating coil pattern layer adjacent to the vessel sensing coil layer among the plurality of heating coil pattern layers.

According to an embodiment of the disclosure, the plurality of heating coil pattern layers may be at least four layers.

According to an embodiment of the disclosure, the plurality of heating coil pattern layers may be eight or more layers.

According to an embodiment of the disclosure, among the plurality of heating coil pattern layers, first to fourth heating coil pattern layers may be electrically connected in parallel, and fifth to eighth heating coil pattern layers may be electrically connected in parallel, and each of pairs of the first and eighth heating pattern layers, the second and seventh heating pattern layers, the third and sixth heating pattern layers, and the fourth and fifth heating pattern layers may be electrically connected in series.

According to an embodiment of the disclosure, a thickness of the heating coil board produced by hot-pressing the plurality of heating coil pattern layers and the plurality of insulating layers for insulation between the plurality of heating coil pattern layers may be 3.3 mm or less.

According to an embodiment of the disclosure, before the hot-pressing, each of the plurality of insulating layers may be formed by stacking two prepreg insulating layers each having a thickness of 70 μm or less.

According to an embodiment of the disclosure, the heating coil board may further include a vessel sensing coil layer including only a vessel sensing coil as an uppermost layer. According to an embodiment of the disclosure, the vessel sensing coil layer may include a temperature detector for measuring a temperature of the heating coil board.

According to an embodiment of the disclosure, the induction heating apparatus may further include a processor configured to control reduction of heating output through the heating coil board when the temperature of the heating coil board measured by the temperature detector is higher than or equal to a predetermined overheating threshold temperature.

According to an embodiment of the disclosure, the temperature detector may include a PTC thermistor or an NTC thermistor.

According to an embodiment of the disclosure, an uppermost layer among the plurality of heating coil pattern layers may include a vessel sensing coil.

According to an embodiment of the disclosure, the induction heating apparatus may further include an inverter board connected to the heating coil board by a connector. According to an embodiment of the disclosure, a lowermost layer of the heating coil board may include a signal layer for connector connection, which is to be connected to the inverter board by the connector.

According to an embodiment of the disclosure, the connector may be mounted on a lower portion of the heating coil board. According to an embodiment of the disclosure, the inverter board may include at least one inverter board connector that is configured to accommodate the connector and is mounted vertically on the inverter board.

According to an embodiment of the disclosure, the induction heating apparatus may further include an intermediate board between the heating coil board and the inverter board, the intermediate board including a memory storing a program for controlling operation of the induction heating apparatus and a processor configured to execute the program stored in the memory to control the induction heating apparatus. According to an embodiment of the disclosure, the intermediate board may include a hole through which the connector passes.

According to an embodiment of the disclosure, the amount of copper used in a PCB base plate for the plurality of heating coil pattern layers may be about 2 oz to about 3 oz.

A method of producing a heating coil board for an induction heating apparatus, according to an embodiment of the disclosure, is provided. The method of producing the heating coil board for the induction heating apparatus, according to the embodiment of the disclosure, may include forming a laminated board including a vessel sensing coil layer having a patterned vessel sensing coil, a plurality of heating coil pattern layers in which heating coils are printed and patterned, and an insulating layer positioned between two adjacent heating coil pattern layers among the plurality of heating coil pattern layers to insulate and bond the plurality of heating coil pattern layers. According to an embodiment of the disclosure, the method of producing the heating coil board for the induction heating apparatus may include producing the heating coil board by hot-pressing the laminated board. According to an embodiment of the disclosure, in the method for producing the heating coil board for the induction heating apparatus, the insulating layer may be formed by overlapping a plurality of insulating layers.

A method according to an embodiment of the disclosure may be implemented in the form of program commands executable by various types of computers and may be recorded on computer-readable recording media. The computer-readable recording media may include program commands, data files, data structures, etc. either alone or in combination. The program commands recorded on the computer-readable recording media may be designed and configured specially for the disclosure or may be known to and be usable by those of skill in the art of computer software. Examples of the computer-readable recording media include magnetic media such as hard disks, floppy disks, and magnetic tapes, optical media such as compact disk ROM (CD-ROM) and digital versatile disks (DVDs), magneto-optical media such as floptical disks, and hardware devices that are specially configured to store and perform program commands, such as ROM, RAM, flash memory, etc. Examples of program commands include not only machine code such as that created by a compiler but also high-level language code that may be executed by a computer using an interpreter or the like.

Some embodiments of the disclosure may also be implemented in the form of recording media including instructions executable by a computer, such as a program module executed by the computer. The computer-readable recording media may be any available media that are accessible by a computer and include both volatile and nonvolatile media and both removable and non-removable media. Furthermore, the computer-readable recording media may include both computer storage media and communication media. The computer storage media include both volatile and nonvolatile, removable and non-removable media implemented using any method or technology for storage of information such as computer-readable instructions, data structures, program modules, or other data. The communication media typically embody computer-readable instructions, data structures, program modules, other data in a modulated data signal such as a carrier wave, or other transmission mechanism, and may include any information transmission media. Furthermore, some embodiments of the disclosure may also be implemented as a computer program product or computer program including instructions executable by a computer.

A machine-readable storage medium may be provided in the form of a non-transitory storage medium. In this regard, the term ‘non-transitory storage medium’ only means that the storage medium does not include a signal (e.g., an electromagnetic wave) and is a tangible device, and the term does not differentiate between where data is semi-permanently stored in the storage medium and where the data is temporarily stored in the storage medium. For example, the ‘non-transitory storage medium’ may include a buffer for temporarily storing data.

According to an embodiment of the disclosure, methods according to the embodiments of the disclosure may be included in a computer program product when provided. The computer program product may be traded, as a product, between a seller and a buyer. The computer program product may be distributed in the form of a machine-readable storage medium (e.g., CD-ROM) or distributed (e.g., downloaded or uploaded) on-line via an application store or directly between two user devices (e.g., smartphones). For online distribution, at least a part of the computer program product (e.g., a downloadable app) may be at least transiently stored or temporally generated in the machine-readable storage medium such as a memory of a server of a manufacturer, a server of an application store, or a relay server.

What is claimed is:

1. An induction heating apparatus comprising:
a vessel sensing coil configured to detect a cooking vessel; and
a heating coil board comprising heating coils to heat the cooking vessel, wherein the heating coil board comprising:
a plurality of heating coil pattern layers in which the heating coils are printed and patterned; and
a plurality of insulating layers for insulation between the plurality of heating coil pattern layers, and
each of the plurality of insulating layers comprises at least two pre-impregnated material (prepreg) insulation layers.

2. The induction heating apparatus of claim 1, wherein each of the plurality of insulating layers comprises a resin content of 60% to 80% of a total composition of each of the plurality of insulation layers.

3. The induction heating apparatus of claim 1, wherein
a height of a conductor of each of the plurality of heating coil pattern layers included in the heating coil board is 60 micrometers (μm) or more, and
each of the plurality of insulating layers has a thickness of 140 μm or less before a hot pressing process.

4. The induction heating apparatus of claim 1, further comprising a temperature sensor configured to detect a temperature of the cooking vessel, wherein the heating coil board comprises a hole through which the temperature sensor passes.

5. The induction heating apparatus of claim 1, wherein the heating coil board comprises a vessel sensing coil layer, and the vessel sensing coil layer including the vessel sensing coil as an uppermost layer.

6. The induction heating apparatus of claim 5, wherein the heating coil board further comprises an insulating layer positioned between the vessel sensing coil layer and a heating coil pattern layer adjacent to the vessel sensing coil layer among the plurality of heating coil pattern layers.

7. The induction heating apparatus of claim 1, wherein the plurality of heating coil pattern layers comprises at least four layers.

8. The induction heating apparatus of claim 1, wherein the plurality of heating coil pattern layers comprises eight or more layers.

9. The induction heating apparatus of claim 1, wherein the plurality of heating coil pattern layers has:
a first heating coil pattern layer;
a second heating coil pattern layer;
a third heating coil pattern layer;
a fourth heating coil pattern layer;
a fifth heating coil pattern layer;
a sixth heating coil pattern layer;
a seventh heating coil pattern layer; and
an eighth heating coil pattern layer,
among the plurality of heating coil pattern layers, the first heating coil pattern layer, the second heating coil pattern layer, the third heating coil pattern layer, the fourth heating coil pattern layer are electrically connected in parallel, and the fifth heating coil pattern layer, the sixth heating coil pattern layer, the seventh heating coil pattern layer, and the eighth heating coil pattern layer are electrically connected in parallel, and
a pair of the first heating pattern layer and the eighth heating pattern layer, a pair of the second heating pattern layer and the seventh heating pattern layer, a pair of the third heating pattern layer and the sixth heating pattern layer, and a pair of the fourth heating pattern layer and the fifth heating pattern layer are each electrically connected in series.

10. The induction heating apparatus of claim 1, wherein a thickness of the heating coil board is 3.3 mm or less.

11. The induction heating apparatus of claim 1, wherein before a hot-pressing process, each of the plurality of insulating layers is formed by stacking two prepreg insulation layers each having a thickness of 70 μm or less.

12. The induction heating apparatus of claim 1, wherein the heating coil board further comprises a vessel sensing coil layer, and the vessel sensing coil layer including the vessel sensing coil as an uppermost layer, and
the vessel sensing coil layer further comprises a temperature detector configured to measure a temperature of the heating coil board.

13. The induction heating apparatus of claim 12, further comprising a processor configured to control a heating output through the heating coil board to be reduced in response to the temperature of the heating coil board measured by the temperature detector being higher than or equal to a predetermined overheating threshold temperature.

14. The induction heating apparatus of claim 12, wherein the temperature detector comprises a positive temperature coefficient (PTC) thermistor or a negative temperature coefficient (NTC) thermistor.

15. The induction heating apparatus of claim 1, wherein an uppermost layer among the plurality of heating coil pattern layers comprises the vessel sensing coil.

16. The induction heating apparatus of claim 1, further comprising
an inverter board connected to the heating coil board by a connector,
wherein a lowermost layer of the heating coil board comprises a signal layer for connector connection, which is to be connected to the inverter board by the connector.

17. The induction heating apparatus of claim 16, wherein
the connector is mounted on a lower portion of the heating coil board, and
the inverter board comprises at least one inverter board connector configured to accommodate the connector and mounted vertically on the inverter board.

18. The induction heating apparatus of claim 17, further comprising
an intermediate board between the heating coil board and the inverter board, the intermediate board comprising:
a memory storing a program for controlling operation of the induction heating apparatus; and
a processor configured to execute the program stored in the memory to control the induction heating apparatus,
wherein the intermediate board includes a hole through which the connector passes.

19. The induction heating apparatus of claim 1, wherein an amount of copper used in a raw printed circuit board (PCB) for the plurality of heating coil pattern layers is about 2 ounces to about 3 ounces.

20. A method of producing a heating coil board for an induction heating apparatus, the method comprising:
forming a laminated board including:
a vessel sensing coil layer having a patterned vessel sensing coil;
a plurality of heating coil pattern layers in which heating coils are printed and patterned; and
an insulating layer positioned between two adjacent heating coil pattern layers among the plurality of heating coil pattern layers to insulate and bond the plurality of heating coil pattern layers; and
producing the heating coil board by hot-pressing the laminated board,
wherein the insulating layer is formed by overlapping a plurality of insulating layers.
